(19) United States
(12) Patent Application Publication
(10) Pub. No.: US 2026/0021500 A1
(43) Pub. Date: Jan. 22, 2026

(54) FLUID SPRAYER HAVING ACTIVE COOLING

(71) Applicant: Graco Minnesota Inc., Minneapolis, MN (US)

(72) Inventors: Steven D. Becker, Inver Grove Heights, MN (US); Adam K. Collins, Brooklyn Park, MN (US); Todd B. Hillukka, Clearwater, MN (US); Jeffrey L. Schwieger, Shakopee, MN (US)

(21) Appl. No.: 18/997,983

(22) PCT Filed: Aug. 8, 2023
(86) PCT No.: PCT/US2023/029752

§ 371 Date: Jan. 23, 2025

Related U.S. Application Data
(60) Provisional application No. 63/396,371, filed on Aug. 9, 2022.

(51) Int. Cl. B05B 9/04; F04B 17/03; F04B 17/06; F04B 53/08

(52) U.S. Cl. CPC B05B 9/0413; F04B 17/03; F04B 17/06; F04B 53/08

(57) ABSTRACT

A fluid sprayer active cooling system is configured to actively cool heat generating components of a spray system. The cooling system includes a fan assembly that is actively controlled between activating and deactivated states to control flow of cooling fluid through a cooling circuit. The fan assembly is operated independently from the motor that powers pumping by a pump of the spray system.

### CROSS-REFERENCE TO RELATED APPLICATION(S)

This application claims priority to U.S. Provisional Application No. 63/396,371 filed Aug. 9, 2022 and entitled “FLUID SPRAYER HAVING ACTIVE COOLING,” the disclosure of which is hereby incorporated by reference in its entirety.

### BACKGROUND

The present disclosure relates generally to fluid displacement systems and, more particularly, to cooling systems for reciprocating fluid displacement pumps.

Fluid displacement systems, such as fluid dispensing systems for paint, typically utilize positive displacement pumps, such as axial displacement pumps, to pull a fluid from a container and to drive the fluid downstream. The axial displacement pump is typically mounted to a drive housing and driven by a motor. A pump rod is attached to a reciprocating drive that drives reciprocation of the pump rod, thereby pulling fluid from a container into the pump and then driving the fluid downstream from the pump. In some cases, electric motors can power the pump. The electric motor and control elements of the fluid displacement system can generate heat during operation.

### SUMMARY

According to an aspect of the disclosure, a fluid sprayer includes a pump that outputs fluid under pressure; a spray gun that sprays fluid output from the pump; an electric motor having a rotor that rotates about a first axis; a drive that receives rotational motion output by the electric motor to operate the pump; a frame that supports the pump and the electric motor; and a fan assembly that generates a flow of cooling fluid that cools the motor, the fan assembly having a blade structure that rotates on a second axis, the second axis non-coaxial with the first axis.

According to an additional or alternative aspect of the disclosure, a fluid sprayer includes a pump that outputs fluid under pressure; a spray gun that sprays fluid output from the pump; an electric motor having a rotor that rotates about a first axis; a drive that receives rotational motion output by the electric motor to operate the pump; a frame that supports the pump and the electric motor; a fan assembly that generates a flow of cooling fluid that cools the motor, the fan assembly having a blade structure that rotates on a second axis; and a cooling circuit having a chamber within which the electric motor is at least partially disposed, a cooling inlet configured to provide cooling fluid from the fan assembly to the chamber, and a cooling outlet configured to output heated cooling fluid from the chamber.

According to another additional or alternative aspect of the disclosure, a fluid sprayer includes a pump that outputs fluid under pressure; a spray gun that sprays fluid output from the pump; an electric motor having a rotor that rotates about a first axis; a drive that receives rotational motion output by the electric motor to operate the pump; a frame that supports the pump and the electric motor; a chamber within which the electric motor is at least partially disposed; a fan assembly that generates a flow of cooling fluid that cools the motor and that is configured to blow the flow of cooling fluid into the chamber, the fan assembly having a blade structure that rotates on a second axis; and a heatsink forming at least one wall of the chamber, the heatsink exposed to the flow of cooling fluid generated by the fan assembly.

According to yet another additional or alternative aspect of the disclosure, a fluid sprayer includes a pump that outputs fluid under pressure; a spray gun that sprays fluid output from the pump; an electric motor having a rotor that rotates about a first axis; a drive that receives rotational motion output by the electric motor to operate the pump; a frame that supports the pump and the electric motor; a fan assembly that generates a flow of cooling fluid that cools the motor, the fan assembly having a blade structure that rotates on a second axis; a first temperature sensor configured to generate temperature information regarding a first sensed temperature; and a controller configured to control operation of the fan assembly, the controller configured to control activation of the fan assembly based on a comparison of the first sensed temperature and a first thermal threshold.

According to yet another additional or alternative aspect of the disclosure, a fluid sprayer includes a pump that outputs fluid under pressure; a spray gun that sprays fluid output from the pump; an electric motor having a rotor that rotates about a first axis; a drive that receives rotational motion output by the electric motor to operate the pump; a frame that supports the pump and the electric motor; a fan assembly that generates a flow of cooling fluid that cools the motor, the fan assembly having a blade structure that rotates on a second axis; and a controller configured to control operation of the fan assembly, the controller configured to control operation of the fan assembly based on a first sensed temperature and a rotational speed of the electric motor.

According to yet another additional or alternative aspect of the disclosure, a fluid sprayer includes a pump that outputs fluid under pressure; a spray gun that sprays fluid output from the pump; an electric motor having a rotor that rotates about a first axis; a drive that receives rotational motion output by the electric motor to operate the pump; a frame that supports the pump and the electric motor; a fan assembly that generates a flow of cooling fluid that cools the motor, the fan assembly having a blade structure that rotates on a second axis; and a controller configured to control operation of the fan assembly, the controller configured to vary a speed of the fan assembly based on a first sensed temperature.

According to yet another additional or alternative aspect of the disclosure, a fluid sprayer includes a pump that outputs fluid under pressure; a spray gun that sprays fluid output from the pump; an electric motor having a rotor that rotates about a first axis; a drive that receives rotational motion output by the electric motor to operate the pump; a frame that supports the pump and the electric motor; a fan assembly that generates a flow of cooling fluid that cools the motor, the fan assembly having a blade structure that rotates on a second axis; and a controller configured to control operation of the fan assembly such that the fan assembly generates the flow of cooling fluid only when the rotor is spinning.

According to yet another additional or alternative aspect of the disclosure, a fluid sprayer includes a pump that outputs fluid under pressure; a spray gun that sprays fluid output from the pump; an electric motor having a rotor that rotates about a first axis; a drive that receives rotational motion output by the electric motor to operate the pump; a frame that supports the pump and the electric motor; a fan assembly that generates a flow of cooling fluid that cools the motor, the fan assembly having a blade structure that rotates on a second axis; and a controller configured to control operation of the fan assembly based on a primary condition primary condition being satisfied.

### BRIEF DESCRIPTION OF THE DRAWINGS

FIG. 1A is a front elevational schematic block diagram of a spray system.

FIG. 1B is a side elevational schematic block diagram of a spray system.

FIG. 2 is an isometric view of a front side of a drive system.

FIG. 3 is an exploded view of a drive system.

FIG. 4 is a cross-sectional view of a drive system.

FIG. 4A is an enlarged view of portion 4A of FIG. 4.

FIG. 5 is an isometric front side view of a support frame for the drive system and displacement pump of FIG. 2.

FIG. 6A shows a cross-sectional view of a spray system.

FIG. 6B is an enlarged view of detail B in FIG. 6B.

FIG. 7 is an exploded view of various components of the spray system shown in FIG. 6A.

FIG. 8 is an isometric view of a drive system.

FIG. 9 is a cross-sectional view of the drive system shown in FIG. 8.

FIG. 10A is an isometric view of a drive system showing a partial cutaway of a housing.

FIG. 10B is an isometric view of drive system similar to FIG. 10A with additional portions of the housing removed.

FIG. 10C is an isometric view of the drive system from a lower side of drive system.

FIG. 10D is a cross-sectional view taken along line D-D in FIG. 10A.

FIG. 10E is a cross-sectional view taken along line E-E in FIG. 10A.

FIG. 11A is an isometric exploded view of a drive system.

FIG. 11B is an enlarged isometric view of the drive system showing a heatsink exploded away from other components of the drive system.

FIG. 12 is a block diagram of a drive system.

FIG. 13 is a flowchart illustrating a control routine for active cooling of a drive system.

FIG. 14 is a control table for controlling a fan assembly for active cooling of a drive system.

### DETAILED DESCRIPTION

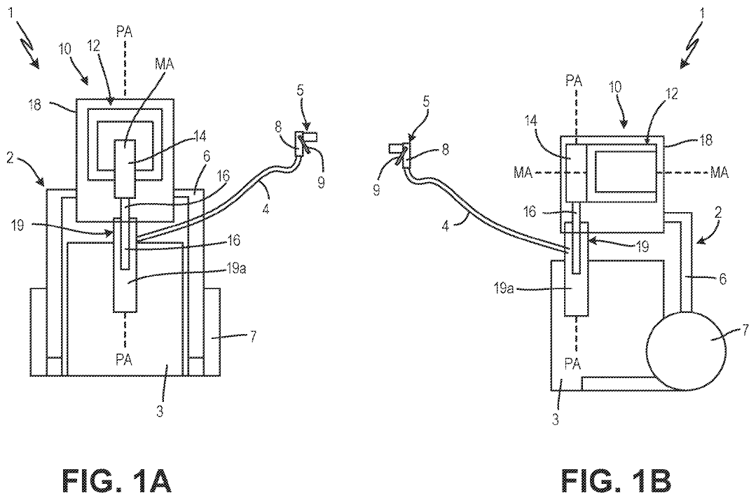

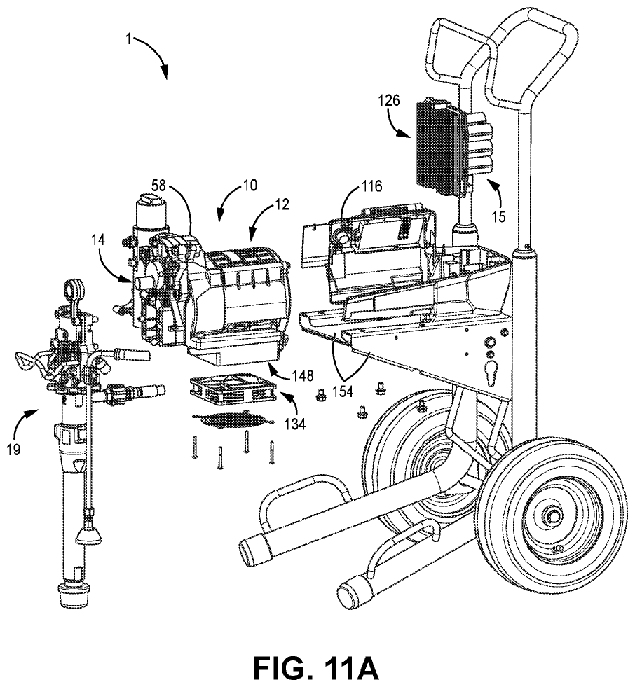

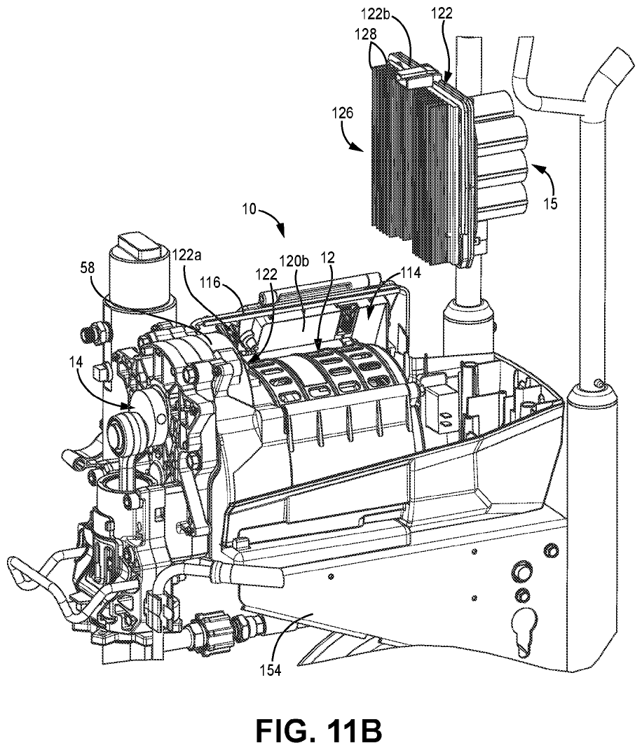

The present disclosure is directed to cooling for a reciprocating fluid displacement pump. The cooling system actively cools the electric drive components of the pump system. Electrically driven systems can generate excess heat and require active cooling via a fan. The present disclosure provides cooling features. The general structure and operation of the fluid sprayer is discussed in connection with FIGS. 1-9 and cooling features are discussed in connection with FIGS. 11-16.

A controller can control operation of the electric motor to cause pumping by the pump. A fan assembly is configured to generate a flow of cooling fluid, such as air, for cooling of the electric motor. The fan assembly can be disposed on a lower side of the drive housing. The fan assembly is disposed such that the fan assembly blows the flow of cooling fluid vertically upwards towards the electric motor.

The electric motor is at least partially disposed in a chamber through which the fan assembly blows the flow of cooling fluid. The electric motor is exposed to the flow of cooling fluid to provide thermal cooling to the electric motor. The cooling circuit through which the flow of cooling fluid flows can be configured such that the cooling fluid enters the chamber vertically below the electric motor and such that the cooling fluid exits the chamber at a location vertically above the electric motor.

The fan assembly pulls in cooling fluid from a bottom side of the drive system. The fan assembly drawing the cooling fluid from the bottom side protects components of drive system from falling spray particulate in the environment of the spray system. The fan assembly is configured such that the spray particulates must move upwards against gravity to reach the fan assembly to be pulled into the chamber. The fan assembly can be recessed from the longitudinal and lateral sides of the drive system to further protect against ingestion of spray particulate. Shielding the fan assembly from falling particulate prevents such particulate from being ingested into chamber, at which location the particulate could coat or otherwise adhere to components of drive system, decreasing the operating efficiency of such components.

The chamber can extend fully around the electric motor around an axis of the electric motor. Such a configuration facilitates the cooling fluid flowing fully circumferentially about the electric motor. The cooling fluid flowing fully circumferentially about the electric motor provides improved cooling efficiency by providing a large surface area of electric motor for exposure to the cooling fluid.

According to some aspects of the present disclosure, a heatsink is exposed to the flow of cooling fluid output by the fan assembly. The heatsink can define a wall of a chamber within which the electric motor is at least partially disposed and into which the fan assembly blows the flow of cooling fluid. The heatsink can be disposed directly between the chamber and a control cavity within which a controller of the spray system is disposed. The heatsink wicks heat generated by the controller to the cooling fluid flow to provide cooling for the controller. In some cases, one or more components are directly mounted to the heatsink to provide greater cooling to those components. In some cases, an insulated-gate bipolar transistor (IGBT) is mounted to the heatsink. The component of the controller can be directly thermally connected to the heatsink to provide a direct thermal pathway between the component of the controller to the flow of cooling fluid via the heatsink.

According to some aspects of the present disclosure, a controller is configured to control operation of the fan assembly. The fan assembly can be operated independently of the electric motor. The fan assembly can be run to generate the flow of cooling fluid when the electric motor is not running and the fan assembly can be deactivated to not generate the flow of cooling fluid when the electric motor is running. The fan assembly is mechanically separated from the electric motor and is separate from the electric motor.

The controller can be configured to vary a speed of the fan assembly. The controller can vary the speed of the fan assembly based on one or more operating parameters of the spray system. According to some aspects of the disclosure, the operating parameter can be a sensed temperature. The controller can vary the speed of the fan assembly based on the sensed temperature. According to some aspects of the disclosure, the operating parameter can be a rotational speed of the electric motor. The controller can vary the speed of the fan assembly based on the rotational speed.

The controller can be configured to operate the fan assembly based on multiple operating parameters. According to some aspects of the disclosure, the controller can cause the fan assembly to operate to generate the flow of cooling fluid based on multiple of the operating parameters being satisfied. For example, the controller can cause the fan assembly to operate if both a sensed temperature satisfies a temperature threshold and the motor is actually operating, such as to generate a rotational output.

The controller can be configured to operate the fan assembly based on multiple, tiered thresholds relative to an operating parameter. The controller can be configured to control operation of the fan assembly in different operating modes based on which of the multiple thresholds is satisfied. For example, the controller can cause the fan assembly to operate according to a first operating mode if the operating parameter satisfies a lower threshold and can cause the fan assembly to operate according to a second operating mode if the operating parameter satisfies a higher threshold.

FIG. 1A is a front elevational schematic block diagram of spray system 1. FIG. 1B is a side elevational schematic block diagram of spray system 1. FIGS. 1A and 1B are discussed together. Support 2, reservoir 3, supply line 4, spray gun 5, and drive system 10 are shown. Drive system 10 includes electric motor 12, drive mechanism 14, pump frame 18, and displacement pump 19. Support 2 includes support body 6 and wheels 7. Fluid displacer 16 and pump body 19a of displacement pump 19 are shown. Spray gun 5 includes a handle 8 and trigger 9.

Spray system 1 is a system for applying sprays of various fluids, examples of which include paint, water, oil, stains, finishes, aggregate, coatings, and solvents, amongst other options, onto a substrate. Drive system 10, which can also be referred to as a pump assembly, can generate high fluid pumping pressures, such as about 3.4-69 megapascal (MPa) (about 500-10,000 pounds per square inch (psi)) or even higher. In some examples, the pumping pressures are in the range of about 20.7-34.5 MPa (about 3,000-5,000 psi). High fluid pumping pressure is useful for atomizing the fluid into a spray for applying the fluid to a surface.

Drive system 10 is configured to draw spray fluid from reservoir 3 and pump the fluid downstream to spray gun 5 for application on the substrate. Support 2 is connected to drive system 10 and supports drive system 10 relative to reservoir 3. Support 2 can receive and react loads from drive system 10. For example, support body 6 can be connected to support frame 18 to react the loads generated during pumping. In the example shown, wheels 7 are connected to support body 6 to facilitate movement between job sites and within a job site.

Support frame 18 supports other components of drive system 10. Motor 12 and displacement pump 19 are connected to Support frame 18. Motor 12 is an electric motor having a stator and a rotor. Motor 12 can be configured to be powered by any desired power type, such as direct current (DC), alternating current (AC), and/or a combination of direct current and alternating current. The rotor is configured to rotate about a motor axis MA in response to current, such as direct current or alternating current signals, through the stator. In some examples, the rotor can rotate about the stator such that motor 12 is an outer rotator motor.

Drive mechanism 14 is connected to motor 12 to be driven by motor 12. Drive mechanism 14 can also be referred to as a drive. Drive mechanism 14 receives a rotational output from motor 12 and drives movement of pump 19 to cause pumping by pump 19. For example, drive 14 can convert that rotational output into a linear input along pump axis PA. In the example shown, drive 14 is connected to fluid displacer 16 to drive reciprocation of fluid displacer 16 along pump axis PA. As illustrated in FIG. 1B, motor axis MA is disposed transverse to pump axis PA. In some examples, motor axis MA can be orthogonal to pump axis PA. In the example shown, fluid displacer 16 reciprocates within a pump body 19a, such as cylinder 94 discussed below, to pump spray fluid from reservoir 3 to spray gun 5 through supply line 4.

In some examples, motor 12, drive mechanism 14, and fluid displacer 16 can be disposed coaxially such that motor axis MA and pump axis PA are coaxial. For example, pump 19 can be configured as a rotor-stator pump in which a rotating component is moved relative to a stationary component to pump the fluid, such as a helical rod being rotated within a lobed sleeve.

The pump 19 can be configured to draw fluid into pump through a pump inlet and to output fluid through a pump outlet. The pump body 19a defines a pump chamber through which the fluid is pumped. The fluid displacer 16 divides the pump chamber into an upstream chamber and a downstream chamber. A piston head of the piston forming fluid displacer can divide the pump chamber into the upstream chamber and downstream chamber. The pump 19 can be configured as a double displacement pump that outputs pumped fluid during both a stroke in a first direction along the pump axis PA and a stroke in a second direction along the pump axis PA.

During operation, the user can maneuver drive system 10 to a desired position relative to the target substrate by moving support 2. For example, the user can maneuver drive system 10 by tilting support frame 6 on wheels 7 and rolling drive system 10 to a desired location. In some examples, a handle can extend from drive system 10 and the user can maneuver drive system 10 within a job site or between job sites by grasping the handle and carrying drive system 10. Displacement pump 19 is disposed to draw spray fluid from reservoir 3. In some examples, displacement pump 19 can extend into reservoir 3. Motor 12 provides the rotational input to drive mechanism 14 and drive mechanism 14 provides an input to fluid displacer 16 to drive operation of fluid displacer 16. Fluid displacer 16 draws the spray fluid from reservoir 3 and drives the spray fluid downstream through supply line 4 to spray gun 5.

The user can manipulate spray gun 5 by grasping the handle 8 of the spray gun 5, such as with a single hand of the user. The user causes spraying by actuating trigger 9. Actuating the trigger 9 can open a valve within the spray gun 5 to allow release of the pressurized fluid from the spray gun 5. The fluid can be emitted through a nozzle that atomizes the spray fluid. The nozzle can shape the spray fluid into a desired pattern, such as a fan, cone, etc. In some examples, the pressure generated by drive system 10 atomizes the spray fluid exiting spray gun 5 to generate the fluid spray. In some examples, spray gun 5 is an airless sprayer.

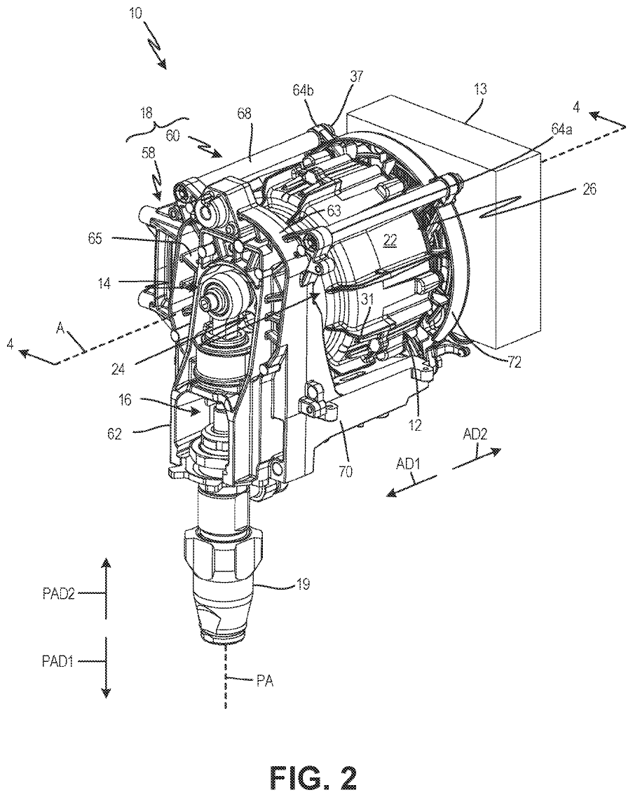

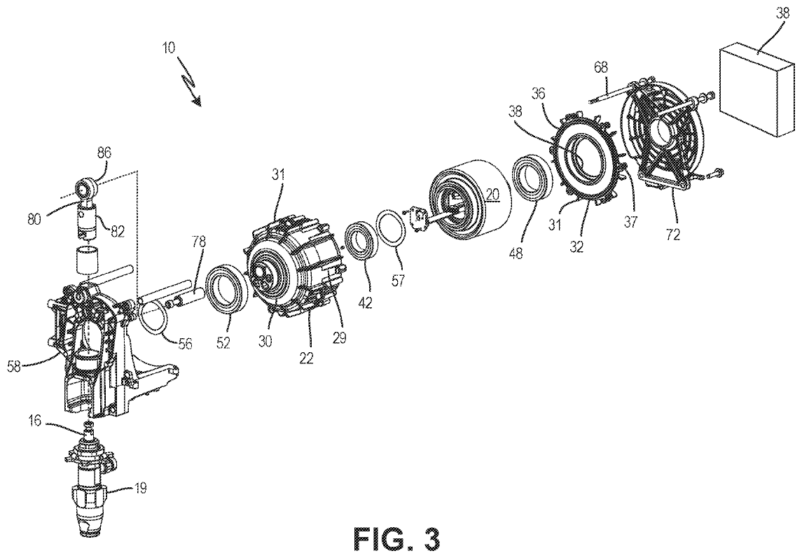

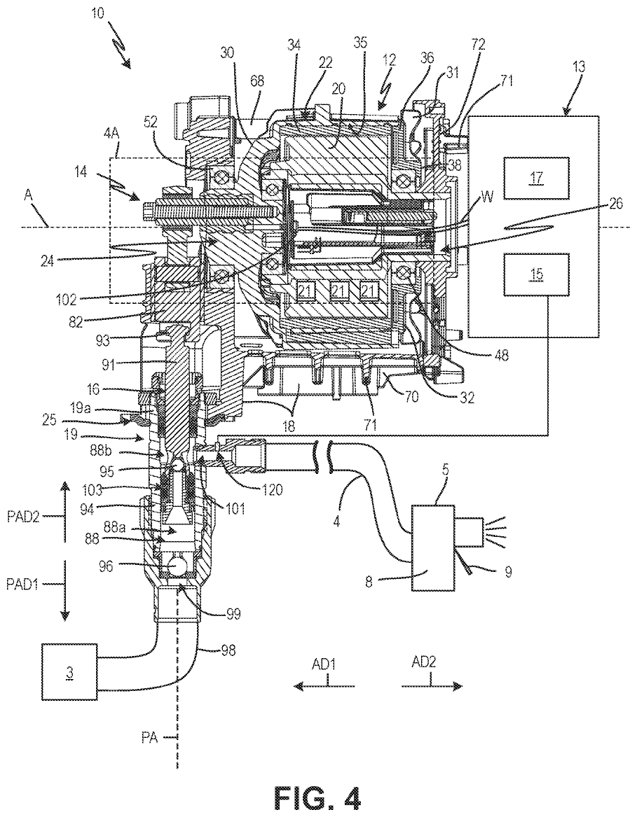

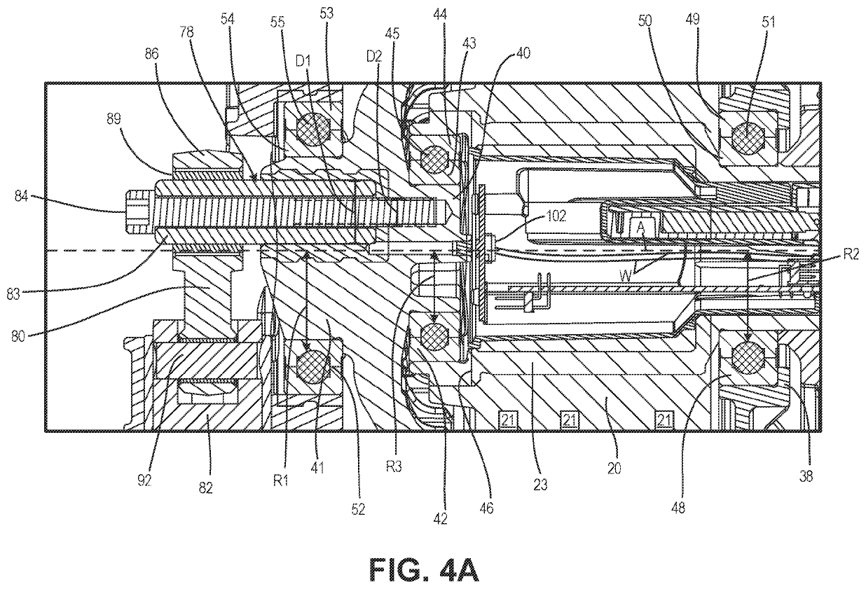

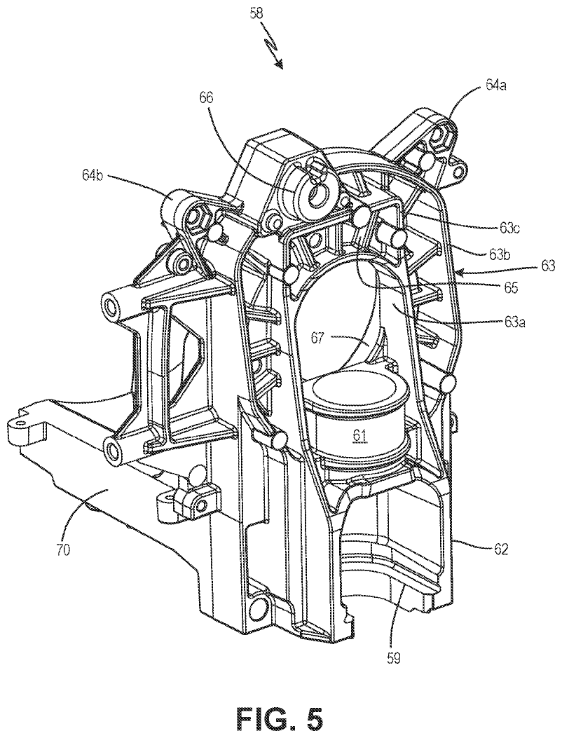

FIG. 2 is an isometric view of a front side of drive system 10. FIG. 3 is an exploded view of drive system 10. FIG. 4 is a cross-sectional view of drive system 10. FIG. 4A is an enlarged view of portion 4A of FIG. 4. FIG. 5 is an isometric front side view of a support frame 18 for the drive system and displacement pump of FIG. 2. Electric motor 12, control panel 13, drive mechanism 14, fluid displacer 16, support frame 18, and displacement pump 19 are shown. FIGS. 2-4 illustrate one embodiment of drive mechanism 14 coupled to an outer rotor electric motor 12 and configured to power reciprocation of a fluid displacement member of pump 19. FIG. 5 illustrates one embodiment of support frame 18 configured to mechanically support electric motor 12 and pump 19.

Electric motor 12 includes stator 20, rotor 22, and axle 23. In the example shown, electric motor 12 is configured as a reversible motor in that stator 20 can cause rotation of rotor 22 in either of two rotational directions about motor axis A (e.g., clockwise or counterclockwise), which can be the same as motor axis MA shown in FIGS. 1A and 1B. It is understood, however, that not all examples are so limited. Electric motor 12 is disposed on axis A and extends from first end 24 to second end 26. First end 24 can be an output end configured to provide a rotational output from motor 12. Second end 26 can be an electrical input end configured to receive electrical power to provide to stator 20 to power operation of motor 12. For example, one or more wires w can extend into electrical input end 26 and to stator 20 to provide electrical power to operate stator 20.

Rotor 22 can be formed of a housing, having cylindrical body 28 disposed between first wall 30 and second wall 32. Cylindrical body 28 extends axially relative to motor axis A between first and second walls 30, 32. First and second walls 30, 32 extend substantially radially inward from cylindrical body 28 and towards motor axis A. Cylindrical body 28 and/or first and/or second walls 30, 32 can have fins 31 projecting radially and/or axially and/or cylindrically from and/or along body 28 and/or walls 30, 32. Cylindrical body 28, first wall 30, and second wall 32 can be considered to form a rotor housing of rotor 22.

Rotor 22 includes permanent magnet array 34 disposed on inner circumferential face 35. Inner circumferential face 35 can be the radially inner side of cylindrical body 28. Second wall 32 can have axially extending flange 36 configured to be received in an inner diameter of cylindrical body 28. Second wall 32 can be fastened to cylindrical body 28 by fasteners, adhesive, welding, press-fit, interference fit, or other desired manners of connection. For example, bolts 37 or another fastener can connect wall 32 and cylindrical body 28. Second wall 32 can have radially extending annular flange 38 at an inner diameter opening. Annular flange 38 can be rotationally coupled to axle 23, such as by bearing 48. Annular flange 38 can at least partially define a receiving shoulder for receiving the outer race 49 of bearing 48 and preloading bearing 48. Rotor 22 can include a plurality of cylindrical projections 40, 41 extending axially from first wall 30. Cylindrical projections 40, 41 can rotationally couple rotor 22 to stator 20 and support frame 18.

Bearing 42, having inner race 43, outer race 44, and rolling elements 45, rotationally couples rotor 22 to stator 20 at axle end 46 opposite second end 26. Bearing 48, having outer race 49, inner race 50, and rolling elements 51, rotationally couples rotor 22 to stator 20 at second end 26.

Support frame 18 is mechanically coupled to rotor 22 at output end 24 via bearing 52, having outer race 53, inner race 54, and rolling elements 55. Rotor 22 can be received in support frame 18, such that a portion of rotor 22 extends into support frame 18 and is radially surrounded by a portion of support frame 18. Bearing 52 can be disposed between rotor 22 and support frame 18 such that both bearing 52 and support frame 18 are positioned radially outward from the portion of rotor 22 at output end 24. Wave spring washer 56 can be disposed between bearing 52 and support frame 18. An additional wave spring washer 57 can be disposed between bearing 42 and axle 23.

Support frame 18 includes pump frame 58 (best seen in FIG. 5) and support member 60. It is understood that the term member can refer to a single piece or multiple pieces fixed together. Pump frame 58 mechanically supports pump 19 and electric motor 12. Pump frame 58 is mechanically coupled to rotor 22 at output end 24 via bearing 52. Pump frame 58 can include pump housing portion 62, outer frame body 63, projections 64a, support ribs 65, handle attachment 66, and hub 67. Support member 60 provides a frame for motor 12. Support member 60 is mechanically coupled pump frame 58 and motor 12 and supports both pump and electric motor reaction forces. Support member 60 extends from pump frame 58 at output end 24 to axle 23 at electrical input end 26. Support member 60 can include connecting members 68, base plate 70, and frame member 72. Frame member 72 can include projections 64b, support posts 73, hub 74, ribs 75, and support rings 76. Base plate 70 can include support posts 71. Pump frame 58 and frame member 72 are disposed on opposite axial ends of motor 12 relative to axis A. A first plane that motor axis A is normal to at output end 24 can extend through pump frame 58. A second plane that motor axis A is normal to at input end 26 can extend through frame member 72. The two planes are spaced axially apart along motor axis A and do not intersect.

Control panel 13 can be mounted to and supported by support frame 18. Specifically, control panel 13 can be mounted to frame member 72 on an opposite axial side of frame member 72 from motor 12 relative to axis A, such that frame member 72 separates control panel 13 from motor 12 and is disposed directly between control panel 13 and motor 12 along axis A. Control panel 13 can be cantilevered from motor 12 via frame member 72. Control panel 13 can be cantilevered from support frame 18. In the example shown, control panel 13 is mounted to frame member at control support posts 73. Control support posts 73 extend axially from frame member 72 and away from motor 12. Control support posts 73 can provide directly contact between thermally conductive elements of frame member 72 and control panel 13, such as a metal-to-metal contact, to facilitate heat transfer, as discussed in more detail below.

Control panel 13 can include and/or support controller 15 and various other control and/or electrical elements of drive system 10. Controller 15 is operably connected to motor 12, electrically and/or communicatively, to control operation of motor 12 thereby controlling pumping by displacement pump 19. Controller 15 can be of any desired configuration for controlling pumping by displacement pump 19 and can include control circuitry and memory. Controller 15 is configured to store software, store executable code, implement functionality, and/or process instructions. Controller 15 is configured to perform any of the functions discussed herein, including receiving an output from any sensor referenced herein, detecting any condition or event referenced herein, and controlling operation of any components referenced herein. Controller 15 can be of any suitable configuration for controlling operation of drive system 10, controlling operation of motor 12, gathering data, processing data, etc. Controller 15 can include hardware, firmware, and/or stored software, and controller 15 can be entirely or partially mounted on one or more boards. Controller 15 can be of any type suitable for operating in accordance with the techniques described herein. While controller 15 is illustrated as a single unit, it is understood that controller 15 can be disposed across one or more boards. In some examples, controller 15 can be implemented as a plurality of discrete circuitry subassemblies. In some examples, controller 15 can be implemented across one or more locations such that one or more, but less than all, components forming controller 15 are disposed in and/or supported by control panel 13. In some examples, controller 15 is disposed at locations other than control panel 13.

Controller 15 can include any one or more of a microprocessor, a digital signal processor (DSP), an application specific integrated circuit (ASIC), a field-programmable gate array (FPGA), or other equivalent discrete or integrated logic circuitry. Computer-readable memory can be configured to store information during operation. The computer-readable memory can be described, in some examples, as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). Computer-readable memory of control module 14 and/or motor controller 22 can include volatile and non-volatile memories. Examples of volatile memories can include random access memories (RAM), dynamic random access memories (DRAM), static random access memories (SRAM), and other forms of volatile memories. Examples of non-volatile memories can include magnetic hard discs, optical discs, flash memories, or forms of electrically programmable memories (EPROM) or electrically erasable and programmable (EEPROM) memories. In some examples, the memory is used to store program instructions for execution by the control circuitry. The memory, in one example, is used by software or applications running on the control module 14 or motor controller 22 to temporarily store information during program execution.

Control panel 13 is further shown as including user interface 17. User interface 17 can be configured as an input and/or output device. User interface 17 can be disposed at locations other than control panel. User interface 17 can be configured to receive inputs and/or provide outputs. Examples of user interface 17 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, a dial, a switch, a graphical user interface (GUI), or other type of device for facilitating input and/or output of information in a form understandable to users or machines. While user interface 17 is shown as being formed as a portion of control panel 13, it is understood that user interface 17 can, in some examples, be disposed remote from control panel 13 and communicatively connected to other components, such as controller 15.

Controller 15 can be configured to control operation of the motor 12 based on a target pressure for the fluid output by the pump 19. Controller 15 can be configured to control operation of a cooling system that cools motor 12. In some examples, controller 15 can be formed as or considered to include fan control circuitry. The fan control circuitry is configured to control operation of a cooling fan that moves air within the cooling system. In some examples, user interface 17 is formed as and/or includes an input interface by which the target pressure can be provided to the controller 15. The input interface can be actuatable between a minimum pressure state, corresponding with a minimum pressure setting for the pump 19, and a maximum pressure state, corresponding with a maximum pressure setting for the pump 19. The user can input a parameter output setting at user interface 17. The input interface is configured to provide parameter setting information to the controller, the parameter setting information indicating the target parameter for output by the pump 19, such as pressure or flow. In some examples, the user interface 17 is configured to provide pressure setting information to the controller 15, the pressure setting information indicating a target pressure for the output from the pump 19. The input interface can be configured to receive an input from a user and provide information regarding the target pressure to the controller 15. For example, the input interface can be configured as a switch, dial, GUI, knob, slider, joystick, etc.

Drive 14 is connected to motor 12 and pump 19. Drive 14 is configured to receive the rotational output from rotor 22 and convert that rotational output into a movement input to fluid displacer 16. In the example shown, drive 14 includes eccentric driver 78, drive member 80, and drive link 82. Eccentric driver 78 can include sleeve 83 and fastener 84. Drive member 80 can include follower 86 and bearing member 89. Drive link 82 can include connecting slot 90 and pin 92.

In the example shown, pump 19 includes fluid displacer 16 configured to reciprocate within cylinder 94 to pump fluid. In the example shown, fluid displacer 16 is a piston configured to reciprocate on pump axis PA to pump fluid. It is understood, however, that fluid displacer 16 can be of other desired configurations, such as a diaphragm, plunger, etc. among other options. In the example shown, fluid displacer 16 includes shaft 91 and connector 93. Pump 19 includes cylinder 94 that is connected to support frame 18. Check valves 95, 96 regulate flow through pump 19. In the example shown, check valve 95 is mounted to the piston forming fluid displacer 16 to travel with the piston. Pump 16 is configured to draw fluid from reservoir 3 through line 98 and to output fluid to spray gun 5 through line 4.

Spray gun 5 is configured to output an atomized spray of the spray fluid. Spray gun 5 is configured as a handheld sprayer in the example shown, including handle 8 configured to be grasped by a single hand of a user and trigger 9 that is configured to be actuated by the user to open a valve in spray gun 5 to allow for spraying of the spray fluid.

Support frame 18 supports motor 22 and pump 19. As discussed in further detail below, support frame 18 is dynamically connected to rotor 22 by a bearing interface and statically connected to stator 20. Support frame 18 is statically connected to pump 19. Electric motor 12 is dynamically connected to support frame 18 via rotor 22 and statically connected to support frame 18 via stator 20. Electric motor 12 is dynamically connected to pump 19 via fluid displacer 16. Pump 19 is statically connected to support frame 18 and dynamically connected to electric motor 12.

In the example shown, motor 12 is an electric motor having inner stator 20 and outer rotor 22. Motor 12 can be configured to be powered by any desired power type, such as direct current (DC), alternating current (AC), and/or a combination of direct current and alternating current. Stator 20 includes armature windings 21 and rotor 22 includes permanent magnets 34. Rotor 22 is configured to rotate about motor axis A in response to current signals through stator 20. Rotor 22 is connected to the fluid displacer 16 at an output end 24 of rotor 22 via drive 14. Drive 14 receives a rotary output from rotor 22 and provides a linear, reciprocating input to fluid displacer 16. Support frame 18 mechanically supports electric motor 12 at the output end 24 and mechanically supports reciprocating fluid displacement pump 19 by the connection between cylinder 94 and pump 19. Support frame 18 at least partially houses fluid displacer 16 of reciprocating pump 19. In the example shown, cylinder 94 is mounted to pump frame 58 by clamp 25 receiving a portion of the support frame between a first member of the clamp 25 and a second member of the clamp 25. For example, flange 59 can be received between the two members of clamp 25.

Stator 20 defines axis A of electric motor 12. Stator 20 is disposed around and supported by axle 23. Axle 23 is mounted to be stationary relative to motor axis A during operation. Stator 20 is fixed to axle 23 to maintain a position of stator 20 relative to motor axis A. Power can be supplied to armature windings 21 by electrical connection made at or through electrical input end 26 of electric motor 12. Each winding 21 can be a part of a phase of the motor 12. In some examples, motor 12 can include three phases. The power can be provided to each phase according to electrically offset sinusoidal waveforms. For example, a motor with three phases can have each phase receive a power signal 120-degrees electrically offset from the other phases. Axle 23 can be a hollow shaft open to electrical input end 26 for receiving electrical wiring from outside of motor 12. In alternative embodiments, axle 23 can be solid, can have a key, can be D-shaped, or other similar design. In some embodiments, axle 23 can be defined by a plurality of cylindrical cross-sections taken perpendicular to axis A that are of varying diameters to accommodate mechanical coupling with support frame 18 at electrical input end 26 of axle 23 and coupling with rotor 22 at an axially opposite end 46 of axle 23. For example, a first end of axle 23 can be disposed radially between stator 20 and rotor 22 and have a larger diameter than the axially opposite end 46 for receiving electrical inputs.

Rotor 22 is disposed coaxially with stator 20 and around stator 20 and is configured to rotate about axis A. Rotor 22 can be formed from a housing having cylindrical body 28 extending between first wall 30 and second wall 32, such that rotor 22 is positioned to extend around three sides of stator 20. Rotor 22 includes a permanent magnet array 34. Permanent magnet array 34 can be disposed on an inner circumferential face 35 of cylindrical body 28. An air gap separates permanent magnet array 34 from stator 20 to allow for rotation of rotor 22 with respect to stator 20. Rotor 22 can overlap stator 20 and axle 23 over a full radial extent of stator 20 and axle 23 at output end 24 of electric motor 12. In some examples, rotor 22 can fully enclose stator 20 and axle 23 at output end 24 of electric motor 12. Rotor 22 can partially or fully overlap stator 20 over a radial extent of stator 20 at electrical input end 26 of electric motor 12. Second wall 32 extends from cylindrical body 28 radially inward toward axle 23. Axle 23 can extend through an opening in second wall 32 concentric with axle 23 and can extend axially outward of second wall 32 in axial direction AD2. Second wall 32 is radially separated from axle 23, by bearing 48 in the example shown, at electrical input end 26 of electric motor 12 to allow rotation of rotor 22 with respect to axle 23.

Generally, stator 20 generates electromagnetic fields that interact with a plurality of magnetic elements of rotor 22 to rotate rotor 22 about stator 20. More specifically, stator 20 includes a plurality of windings 21 that generate electromagnetic fields. The electromagnetic fields generated by windings 21 are radially outward facing, toward rotor 22. Rotor 22 includes either a plurality of permanent magnets 34 circumferentially arrayed within rotor 22, or a plurality of windings that temporarily magnetize metallic material both of which are circumferentially arrayed within rotor 22. In either configuration of rotor 22, the electromagnetic fields generated by the plurality of solenoids 21 of stator 20 attract and/or repel the magnetic elements of rotor 22 to rotate rotor 22 about stator 20. While motor 12 is shown as an outer rotating motor with rotor 22 disposed outside of and around stator 20, it is understood that not all examples are so limited. For example motor 12 can be configured as an inner rotating motor in which rotor 22 is disposed within stator 20 such that stator 20 at least partially surrounds rotor 22.

First and/or second walls 30, 32 of rotor 22 can be formed integrally with cylindrical body 28 or can be mechanically fastened to cylindrical body 28. The mechanical connection to cylindrical body 28 can be formed in any desired manner, such as by fasteners, interference fitting, welding, adhesive, etc. Rotor 22 is formed such that a closed end of rotor 22 is oriented towards the axis PA of reciprocation of pump 19 and such that an open end of rotor 22 in oriented towards control panel 13. The closed end of rotor 22 (formed by wall 30) faces the pump 19 and the open end (formed by wall 32, that is open to facilitate electrical connections) is oriented away from pump 19 along the motor axis A. The open end of rotor 22 is oriented towards control panel 13. In the example shown, the opening through wall 32 is open to the space directly between control panel 13 and motor 22.

In the example shown, second wall 32 is fastened to an outer diameter portion of cylindrical body 28 with a plurality of fasteners, more specifically by bolts 37. Second wall 32 can include axially extending flange 36 at a radially outer end, which can form a sliding fit with an inner diameter of cylindrical body 28.

Cylindrical body 28 and/or one or both of first and second walls 30, 32 can include one or more of fins 31 that extend outward (axially and/or radially) to push air as rotor 22 rotates. Fins 31 can be used, for example, to direct cooling air toward control panel 13. Fins 31 can be formed from thermally conductive material to act as heatsinks to conduct heat away from motor 12. Fins 31 can be formed integrally with other portions of rotor housing, such as cylindrical body 28, or can be separately formed and mounted to portions of the rotor housing. Fins 31 increase the surface area of the rotor housing, assisting in cooling of motor 12.

Bearings 42, 48, and 52 are disposed coaxially on rotational axis A, such that rotating members of bearings 42, 48, and 52 rotate on rotational axis A. Bearings 42, 48, and 52 can be substantially similar in size or can vary in size to support differing loads and to accommodate space constraints. Bearings 42 and 48 can be substantially similar in size, while bearing 52 at output end 24 can be larger to accommodate reciprocating load received by rotor 22 at output end 24. In some examples, all three bearings 42, 48, 52 can have different sizes. Rolling elements 55 of bearing 52 can be disposed at a first radius R1 from rotational axis A of electric motor 12, rolling elements 51 of bearing 48 can be disposed at a second radius R2 from rotational axis A, and rolling elements 45 of bearing 42 can be disposed at a third radius R3 from rotational axis A. As illustrated in FIG. 4A, first radius R1 can be greater that a second radius R2 and third radius R3 can be greater the second radius R2 and less than the first radius R1. In some examples, second radius R2 is one of greater than and equal to third radius R3.

Components can be considered to radially overlap when the components are disposed at a common position along an axis (e.g., along the motor axis A for axle 23 and wall 30) such that a radial line projecting that axis extends through each of those radially overlapped components. Similarly, components can be considered to axially overlap when the components are disposed at common positions on or spaced radially from the axis (e.g., relative to motor axis A for axle 23 and wall 30) such that an axial line parallel to or coaxial with the axis extends through each of those axially overlapped components.

First wall 30 of rotor 22 can extend into axle 23 at output end 24 such that a portion of axle 23 and a portion of first wall 30 axially overlap. As such, an axial line parallel to axis A can extend through each of first wall 30 and axle 23. Cylindrical projection 40 of rotor 22 can extend in axial direction AD2 from output end 24 of motor 12 and into axle 23 at axle end 46. As such, cylindrical projection 40 extends from a front end of the housing of rotor 22 and axially away from pump frame 58. Cylindrical projection 40 is coaxial with rotor 22 and stator 20 on rotational axis A and rotates about rotational axis A. Cylindrical projection 40 can extend into axle 23 such that cylindrical projection 40 radially overlaps with axle 23. As such, a radial line extending from axis A can pass through each of cylindrical projection 40 and axle 23. Cylindrical projection 40 is rotationally coupled to axle 23 by bearing 42.

Rotor 22 can be rotationally coupled to stator 20 at electrical input end 26 via bearing 48. Bearing 48 includes outer race 49, inner race 50, and rolling elements 51. Rotor 22 can be coupled to outer race 49 and axle 23 can be coupled to inner race 50. Rolling elements 51 allow rotation of rotor 22 with respect to stator 20 such that rotor 22 rides outside of bearing 48. In some examples, bearing 48 can be a roller or ball bearing in which rolling elements 51 are cylindrical members or balls. Second wall 32 can be coupled to an outer diameter surface of outer race 49 and can extend around an axially outer end face of outer race 49. Axle 23 can extend through rotor 22 at electrical input end 26 and can project axially outward of bearing 48 in axial direction AD2 to allow for coupling of axle 23 with support frame 18, such as via support member 60.

The pump reaction forces experienced by bearing 48 are in a generally opposite axial direction (PAD1, PAD2) as compared to the pump reaction forces simultaneously experienced by bearing 52. The pump reaction loads are transmitted through bearing 52 to support frame 18. One or both of bearings 42 and 48 can be omitted from drive system 10 in some embodiments.

Rotor 22 is mechanically coupled to support frame 18 at output end 24 via bearing 52. Bearing 52 includes inner race 54, outer race 53, and rolling elements 55. Bearing 52 can be a roller or ball bearing, in which rolling elements 55 are cylindrical members or balls. Rotor 22 can be received in pump frame 58, such that a portion of rotor 22 extends into pump frame 58 and is radially surrounded by a portion of pump frame 58. Bearing 52 can be disposed between rotor 22 and pump frame 58 such that both bearing 52 and pump frame 58 are positioned radially outward from rotor 22 at output end 24. Rotor 22 can be coupled to inner race 54 and pump frame 58 can be coupled to outer race 53, such that rotor 22 rides inside of bearing 52. Rolling elements 55 allow rotational motion of rotor 22 relative to pump frame 58.

Rotor 22 can include cylindrical projection 41 extending in axial direction AD1 from wall 30 of rotor 22. Cylindrical projection 41 can extend axially outward in direction AD1 from the output end 24 or front end of electric motor 12 and can extend into an opening in pump frame 58. Cylindrical projection 41 is centered on rotational axis A and rotates about rotational axis A with rotor 22. Bearing 52 can be disposed on an outer diameter portion of cylindrical projection 41 to couple rotor 22 to pump frame 58 by the cylindrical projection 41. Cylindrical projection 41 can extend at least partially into pump frame 58 along axis A. In some examples, cylindrical projection 41 does not extend fully through pump frame 58 such that cylindrical projection 41 does not project in the first axial direction AD1 beyond the structure of pump frame 58. In some examples, cylindrical projection 41 does extend fully through pump frame 58 such that a portion of cylindrical projection 41 projects in axial direction AD1 beyond the structure of pump frame 58.

As used herein, the term “axially outer” refers to a surface facing outward of electric motor 12 (i.e., away from stator 20 along axis A) and the term “axially inner” refers to a surface facing an inner portion (i.e., towards stator 20 along axis A) of electric motor 12. A portion of an axially outer end face of wall 30 can axially overlap with and abut an axially oriented end face of inner race 54 (oriented in axial direction AD2 in the example shown). Wall 30 can thereby form a support for bearing 52. The portion of the axially outer end face of wall 30 can extend radially outward from cylindrical projection 41 and fully annularly around cylindrical projection 41 to axially overlap and abut a full circumferential axially inner end face of inner race 54. For example, wall 30 can include an annular axially extending projection circumscribing cylindrical projection 41 and extending approximately equal to or less than a height of inner race 54 to interface with inner race 54. The projection is configured to fix an axially inner location of bearing 52 and to axially separate wall 30, which rotates, from outer race 53, which is stationary.

Bearings 52 and 48 react to pump reaction loads generated during pumping. Bearings 52, 48 facilitate a direct drive configuration of drive system 10. Bearings 52 and 48 stabilize rotor 22 to facilitate the direct drive connection to fluid displacer 16. The pump reaction forces experienced at output end 24 and input end 26 by bearings 52, 48 are transmitted to the portion of support frame 18 connected to a stand or otherwise supporting drive system 10 on a support surface. In the example shown, the pump reaction forces are transmitted to base plate 70 via pump frame 58, frame member 72, and connecting members 68, balancing the forces across support frame 18. Base plate 70 reacts the forces, such as to a stand connected to mounts 71, and the forces are thereby transmitted away from motor 12. All pump and motor forces are reacted through base plate 70, which can be integrally formed with or directly connected to pump frame 58 and is mechanically coupled to motor axle 23 via frame member 72. The connection balances motor 12, providing longer life, less wear, less downtime, more efficient operation, and cost savings.

Support frame 18 mechanically supports electric motor 12 at output end 24 and at least partially houses fluid displacer 16. Support frame 18 can be mechanically coupled to both rotor 22 and stator 20. Support frame 18 can be mechanically coupled to rotor 22 at output end 24 and mechanically coupled to axle 23 at electrical input end 26. As such, support frame 18 can extend fully around motor 12 and be coupled to axially opposite ends of motor 12 to support motor 12. Axle 23 is mechanically coupled to support frame 18 to fix stator 20 relative to support frame 18.

Support member 60 can extend around an exterior of rotor 22 from pump frame 58 to axle 23 to connect pump frame 58 to axle 23 such that stator 20, via support member 60, is fixed relative to support frame 18. Support member 60 can be removably fastened to axle 23. Support member 60 fixes axle 23 to pump frame 58 to prevent relative movement between stator 20 and support frame 18. In the example shown, neither axle 23 nor stator 20 are fixed to support frame 18 at output end 24. Instead, a portion of rotor 22 is disposed axially between and separates axle 23 and stator 20 from support frame 18. As such, motor 12 is dynamically supported by support frame 18 at the output end 24 and statically supported by support frame 18 at the input end 26.

Support member 60 can extend from a location radially inward of an exterior of cylindrical body 28 of rotor 22 to a location radially outward of cylindrical body 28. Support member 60 can extend circumferentially around rotor 22 with sufficient radial spacing therefrom to allow unobstructed rotation of rotor 22 inside of support member 60. In the example shown, support frame 18 does not completely enclose rotor 22. It is understood that not all examples are so limited. In the example shown, no parts exist between support frame 18 and the exterior of rotor 22. Thus, support frame 18 allows airflow through itself and over rotor 22.

In a non-limiting embodiment, connecting members 68 can be tie rods, which can be circumferentially spaced around a top portion of motor 12. The tie rods can be removably mounted to one or both of pump frame 58 and frame member 72. Base plate 70 can be a substantially solid base plate or bracket disposed under a bottom portion of motor 12. Base plate 70 can have a width substantially equal to a width of pump housing portion 62. In some embodiments, base plate 70 can have a width substantially equal to or greater than a diameter of cylindrical body 28 of rotor 22.

Frame member 72 can include hub 74. Frame member 72 can be removably coupled to axle 23. For example, frame member 72 can be slidingly engaged with axle 23. In some examples, frame member 72 can be fixed to axle 23.

In addition to providing mechanical support to motor 12, support member 60 can conduct heat away from motor 12 during operation. Axle 23 extends through rotor 22 and axially outward from rotor at electrical input end 26 and can project in axial direction AD2 outward of bearing 48. The portion extending axially beyond bearing 48 can connect with support member 60 and provide a route for conductive heat transfer from stator 20 to support member 60 and away from electric motor 12. More specifically, frame member 72 is fixed to axle and in a direct heat exchange relationship therewith. Frame member 72 can be configured to conduct heat from both motor 12 and control panel 13, which are the main heat generating components of drive system 10.

Both axle 23 and support member 60 can be formed of a thermally conductive material (e.g., metal). Axle 23 can be placed in direct contact with support member 60 (e.g., with frame member 72) to provide a direct conductive heat path to route heat away from motor 12. As illustrated in FIG. 4, axle 23 radially overlaps stator 20 along a full axial length of stator 20. Axle 23 is capable of drawing heat from stator 20 and conducting heat toward electrical input end 26 and axially outward of stator 20. Axle 23 transfers heat to frame member 72 via conduction at locations where frame member 72 is in contact with axle 23. As such, the conductive pathway for heat transfer from stator 20 extends through axle 23 to frame member 72. In some embodiments, frame member 72 can be in fixed contact with both an axially extending surface of axle 23 and a radially extending end face of axle 23. For example, a portion of frame member 72, such as a lip extending from hub 74, can extend radially over an end of axle 23 to increase the surface area of the direct contact and transfer heat away from axle 23 and away from electric motor 12. A shape and surface area of frame member 72 can be selected to facilitate heat transfer away from electric motor 12.

Controller 15 can receive a signal from a position sensor 102 (shown in FIGS. 4 and 4A). Position sensor 102 can be included in any of the disclosed drive systems. Position sensor 102 is configured to generate positional information regarding a component of spray system 10. For example, position sensor 102 can be configured to sense a rotational position of rotor 22, a position of fluid displacer 16, a position of the rotating component of drive 14, etc.

FIG. 5 shows a front isometric view of one embodiment of pump frame 58 with base plate 70. Pump frame 58 and base plate 70 can be integrally formed, such as by, for example, casting as a unitary component, or can be formed from multiple components mechanically fixed together. For example, pump frame 58 and base plate 70 can be removably connected together, such as by bolts or other fasteners. Pump frame 58 can include drive link housing 61, pump housing portion 62, inner frame body 63a, outer frame body 63b, mid-frame body 63c, projections 64a with distal ends disposed radially outward of electric motor 12, support ribs 65, handle attachment 66, and hub 67. Pump frame 58 provides mechanical support and housing for pump 19.

Pump frame 58 provides mechanical support for motor 22. Pump frame 58 can extend radially outward from bearing 52. Bearing 52 can be received in hub 67. Rotor 22 can be received through an opening in inner frame body 63a. Outer frame body 63b is positioned radially outward of inner frame body relative to motor axis A. Mid-frame body 63c is positioned between inner frame body 63a and outer frame body 63b. Ribs 65 can extend between inner frame body 63a and mid-frame body 63c, between inner frame body 63a and outer frame body 63b, and between mid-frame body 63c and outer frame body 63b. Ribs 65 can be used to reduce a weight of pump frame 58 while providing structural support. In some embodiments, a plurality of ribs 65 can extend between hub 67 and outer frame body 63b. Ribs 65 can support load from bearing 52 and can reduce weight of pump frame 58. Ribs 65 can be spaced substantially circumferentially around a portion of hub 67. Ribs 65 can vary in length depending on a shape of outer frame body 63b or positioning relative to bearing 52, inner frame body 63a, or mid-frame body 63c. Projections 64a can be substantially solid triangular projections extending from hub 67. Projections 64a can form attachment points for members 68 to secure frame member 72 to pump frame 58.

Drive link housing 61 can be positioned in the opening in inner frame body 63a. As illustrated in the example in FIG. 5, drive link housing 61 is a cylindrical body positioned below the opening and above pump housing portion 62. An opening of drive link housing 61 is orthogonal to the opening through inner frame body 61. Drive link housing 61 limits movement of drive link 82 to up and down motion along pump axis PA.

Pump housing portion 62 of pump frame 58 at least partially houses fluid displacer 16 and supports displacement pump 19. Pump 19 is disposed at output end 24 on pump axis PA orthogonal to motor axis A and axially aligned with drive mechanism 14 along axis A. Pump housing portion 62 of pump frame 58 can extend in an axial direction AD1 outward of drive mechanism 14 to house fluid displacer 16. As illustrated in the example in FIG. 5, pump housing portion 62 is formed by U-shaped walls opening to a front end of pump frame 58 away from motor 12 in axial direction AD1. A portion of pump 19 is disposed in the chamber of pump housing portion 62 during operation.

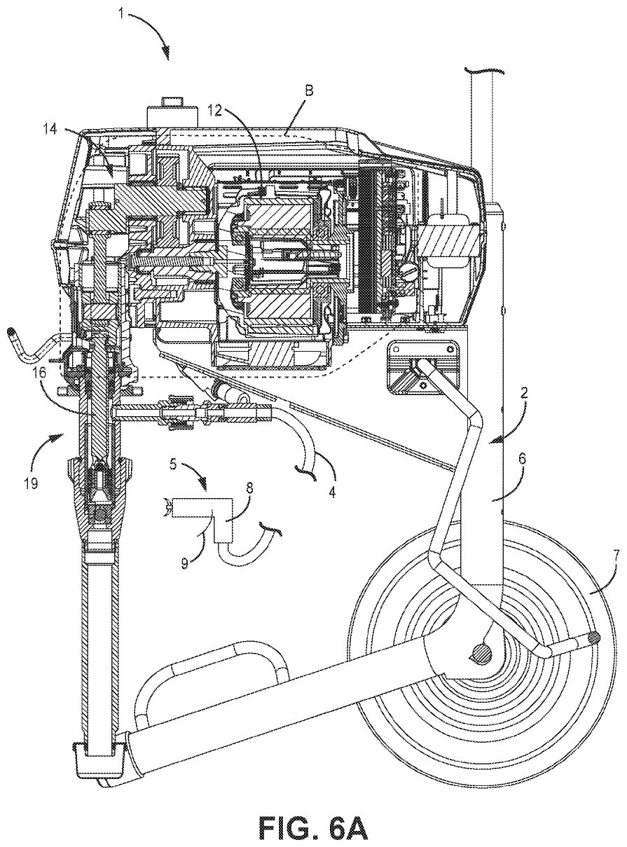

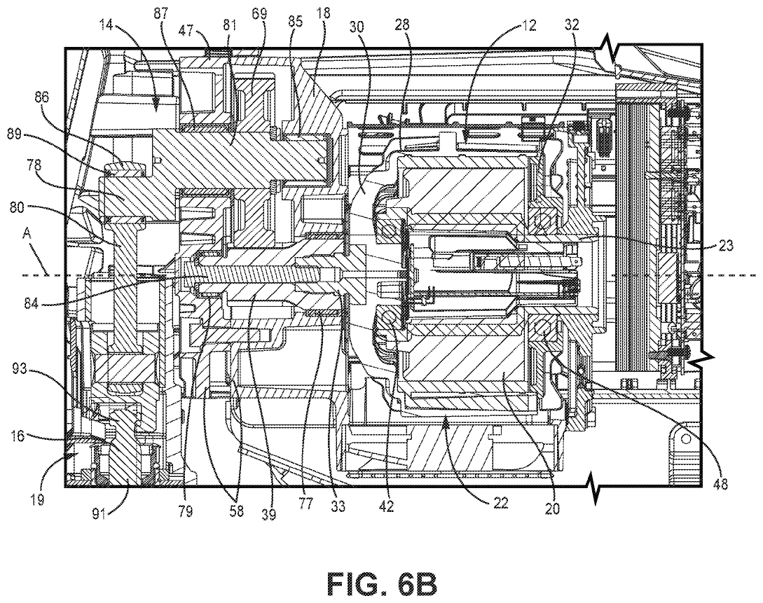

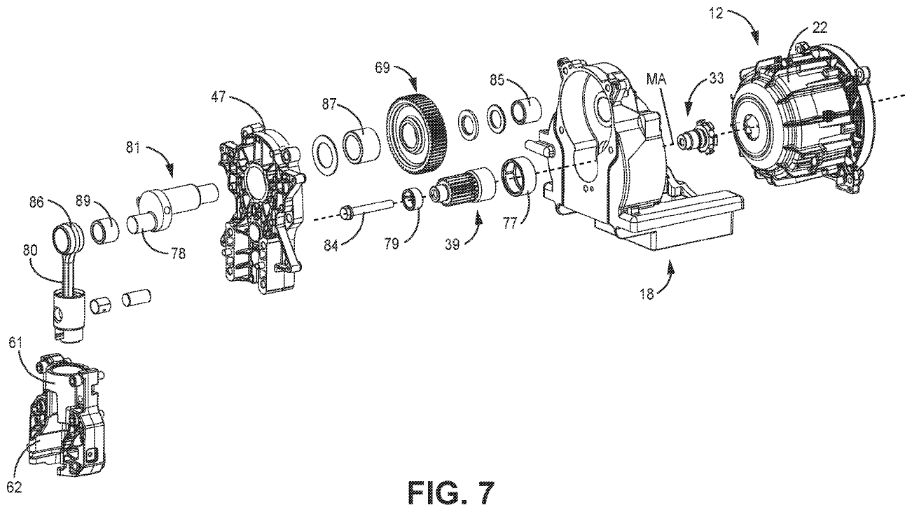

FIGS. 6A-7 show a different embodiment than that of the previous figures. However, the embodiments are similar to each other and any detail referenced in connection with one embodiment either is present in the other embodiment or can be present in the other embodiment. As such, all aspects between embodiments can be assumed to be the same unless shown and/or described to be clearly different such that the descriptions and drawings for one embodiment are applicable to the other embodiment. Various common aspects are not repeated between embodiments for brevity.

Components having the same reference numbers can be the same such that descriptions and/or drawings for one component can be imputed to another component, having the same reference number, of a different embodiment. Likewise, components having the same name can be the same such that descriptions and/or drawings for one component can be imputed to another component, having the same name, of a different embodiment.

FIG. 6A shows a cross-sectional view of spray system 1. Spray system 1 can be similar to the previous embodiment except that the drive mechanism 14 is different.

FIG. 6B is an enlarged view of detail B in FIG. 6B. In this embodiment, the rotor 22 rotates circumferentially around the stator 20 and is disposed radially outwards of the stator 20. The motor 12 is the same as in previous embodiments except for how the rotor 22 is connected to drive mechanism 14 to power drive mechanism 14. Specifically, in the prior examples, an eccentric was attached directly to the housing of the rotor 22 such that the rotor 22 and eccentric rotated in a 1:1 relationship. In the example shown in FIGS. 6A-7, a pinion cap 39 is attached to the rotor 22 and rotates with the rotor 22. More specifically, a stud 33 is integral (e.g., contiguous material) with the rotor housing or is attached to the rotor housing. The pinion cap 39 is mounted on the stud 33. The pinion cap 39 rotates with the rotor 22 about axis A. The pinion cap 39 is fixed to the stud 33 in part by fastener 84. Fastener 84 can be a bolt which extends within the pinion cap 39 from the second end of the pinion cap 39 to the first end of the pinion cap 39.

In this embodiment, the stud 33 includes external threading which interfaces with internal threading of the pinion cap 39. The orientation of the relative threading can be in a first direction (e.g., clockwise or counterclockwise). Stud 33 also includes internal threading within a receiver of the stud 33. The internal threading of the stud 33 interfaces with external threading on the end of the fastener 84. The orientation of the relative threading between the stud 33 and fastener 84 can be in a second direction opposite of the first direction such that the connection between the stud 33 and the pinion cap 39 is maintained even if the motor 12 reverses its direction of rotation. Fastener 84 can be a bolt.

In alternative embodiments, the pinion cap 39 is keyed (e.g., hexed) to the stud 33 instead of a threaded connection to prevent relative rotation.

The pinion cap 39 is supported by first bearing 77 and second bearing 79. Both bearings can be a needle type bearing. The first bearing 77 is supported by support frame 18. The second bearing 79 is supported by retainer plate 47. As such, a first end of the pinion cap 39 engages first bearing 77 while a second and of the pinion cap 39 engages second bearing 79 and a section of the pinion cap 39 between the first and the second ends contains gear teeth. In this way, the pinion cap 39 includes an exterior gear teeth section. The exterior gear teeth section engages teeth of gear 69. Gear 69 rotates with pinion cap 39 however at a slower rate due to the gear reduction between the pinion cap 39 and the gear 69. Bolts can fasten retainer plate 47 to the support frame 18. To capture the pinion cap 39 therebetween.

The gear 69 is supported by eccentric 81. Specifically, the gear 69 is fixed to the eccentric 81 so that the eccentric 81 rotates 1:1 with the gear 69. The eccentric 81 is supported by third bearing 85 and forth bearing 87 (which can also be needle type) which allows the eccentric 81 to rotate. The third bearing 85 is supported by support frame 18 while the fourth bearing 87 is supported by retainer plate 47. The eccentric 81 includes eccentric driver 78 which rotates offset from the center of rotation of the rest of the eccentric 81. Follower 86 and bearing member 89 are mounted on the eccentric driver 78 to follow a circular pattern that moves drive member 80 up and down which reciprocates the fluid displacer 16 of pump 19 for pumping.

FIG. 7 shows an exploded view of various components of the embodiment of FIGS. 6A and 6B. As shown, the pinion cap 39 includes a first end which is covered by first bearing 77, a second end which is covered by second bearing 79, and a gear teeth section between the first and second ends. This gear teeth section interfaces with teeth of gear 69. In the example shown, the pinion cap 39 is connected to the gear 69 such that gear 69 rotates less than one full rotation for each full rotation of rotor 22. As such, rotor 22 is configured to complete multiple full rotations for a single pump cycle of the pump 19.

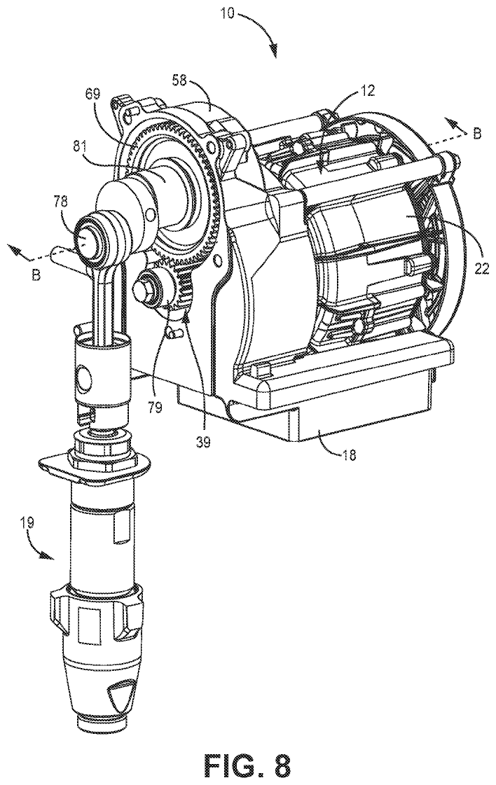

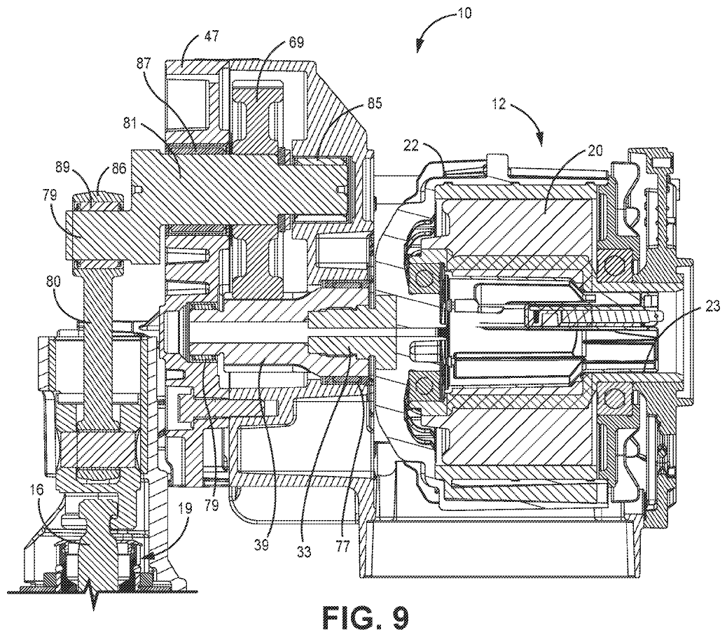

FIG. 8 is an isometric view of a drive system 10. FIG. 9 is a cross-sectional view of the drive system shown in FIG. 8. FIGS. 8 and 9 shows a different embodiment as that of FIGS. 6A-7. All previous teachings reference numbers apply to the embodiment of FIGS. 8 and 9 as they do to the previous embodiments. This embodiment also includes a pinion cap 39. However, the pinion cap 39 is mounted on the stud 33 without the use of a bolt. The pinion cap 39 can be threaded or welded to the stud 33, among other options. In some examples, the pinion cap 39 and/or stud 33 can be formed monolithically with the housing of the rotor 22.

In the present embodiments, no shaft extends entirely axially through the motor, whether part of the pinion or not. In this case, a pinion cap 39 is mounted onto an outer rotor, the pinion cap 39 including the gear teeth section having teeth for interfacing with the gear 69. The pinion cap 39 does not extend through the motor. Rather, the pinion cap 39 is only connected with an outer housing of the rotor 22. The pinion cap 39 is supported by dual bearings on opposite ends, with a third section (e.g., gear teeth section) being axially between the opposite ends supported by the bearings. In the example shown, the rotor 22 includes an open end that faces away from the pump.

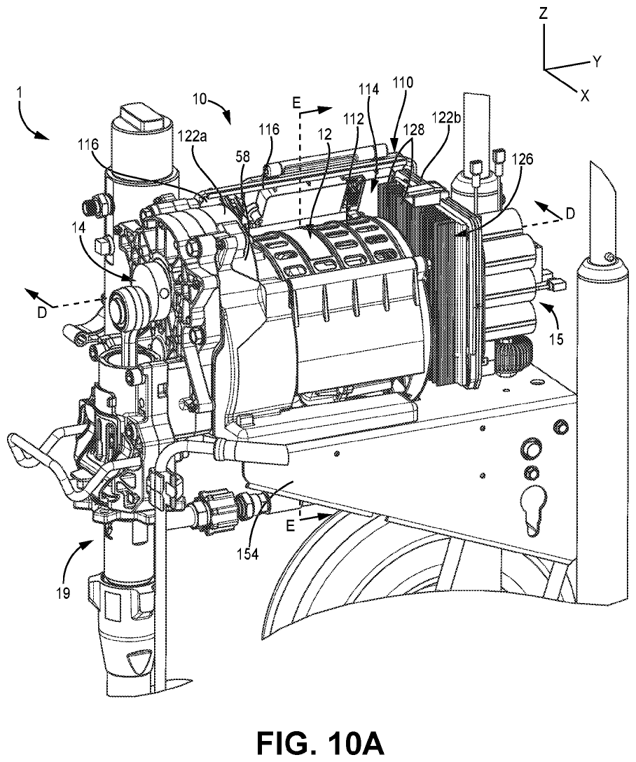

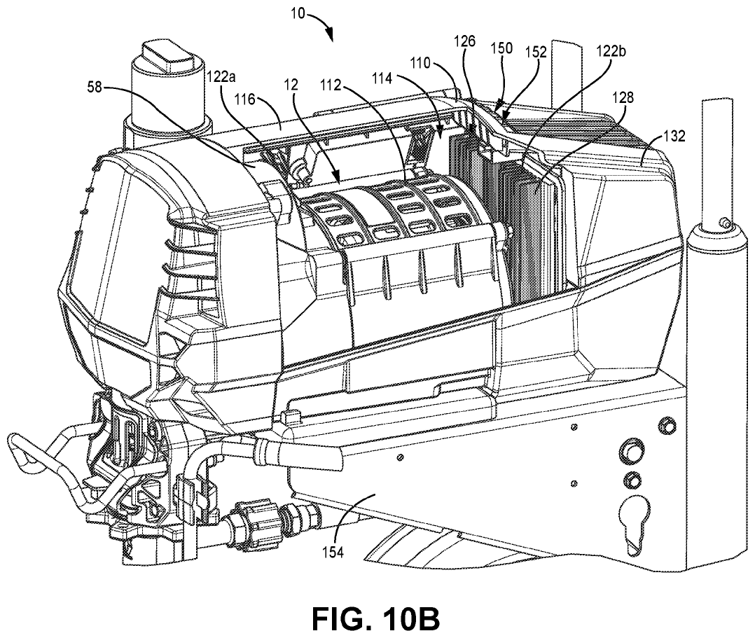

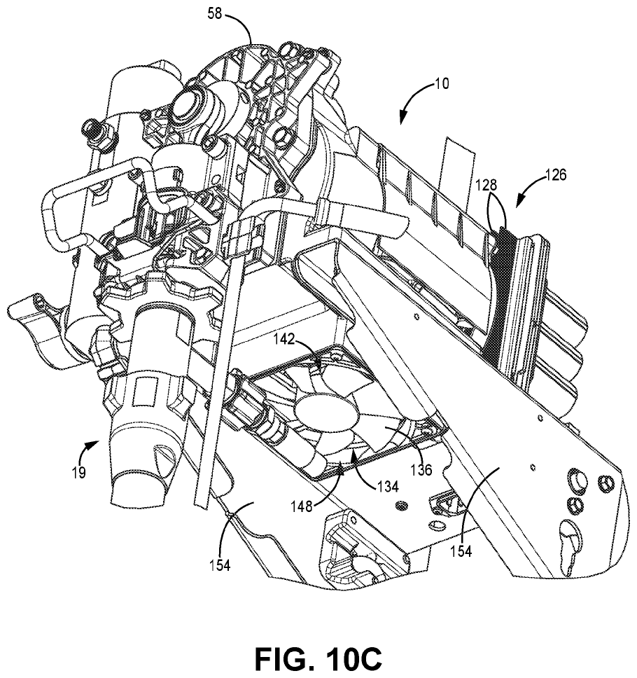

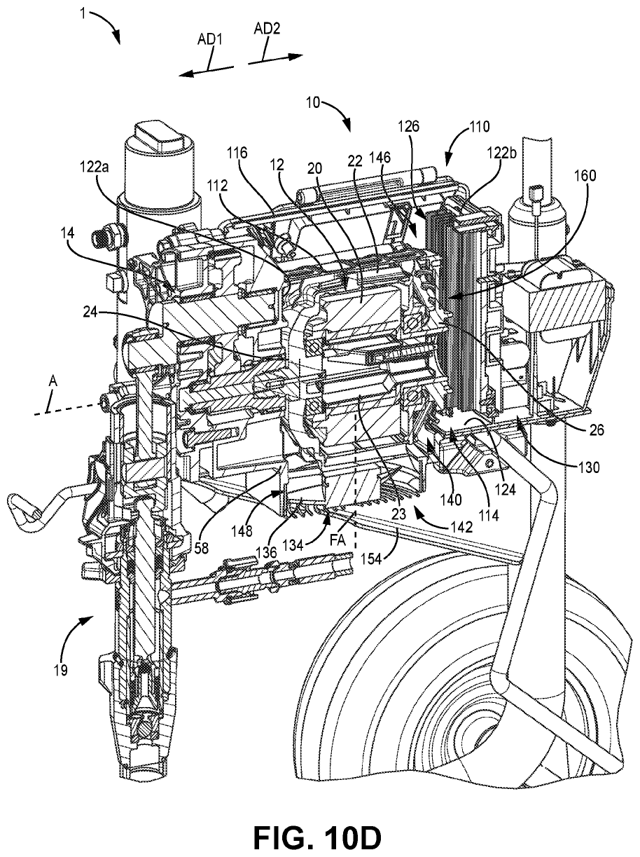

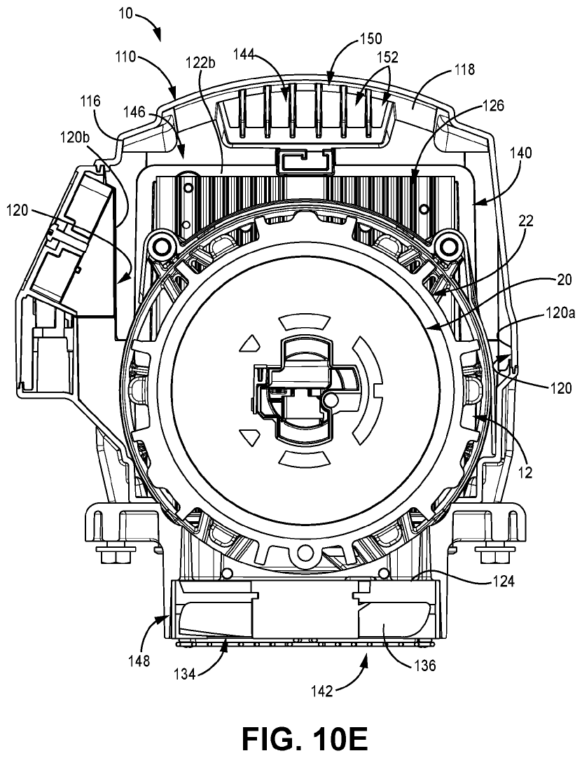

FIG. 10A is an isometric view of spray system 1 showing a partial cutaway of a housing of drive system 10. FIG. 10B is an isometric view of spray system 1 with portions of housings of drive system 10 removed for ease of illustration. FIG. 10C is an isometric view of drive system 10 from a bottom side of drive system 10. FIG. 10D is a cross-sectional view taken along line D-D in FIG. 10A. FIG. 10E is a cross-sectional view taken along line E-E in FIG. 10A. FIG. 11A is an exploded view of spray system 1. FIG. 11B is an enlarged isometric view of drive system 10 showing heatsink 126 exploded away. FIGS. 10A-11B are discussed together. In the example shown, drive system 10 is configured to be disposed along a longitudinal, lateral, and vertical axes. The directions are taken relative to the XYZ coordinate system shown I FIG. 10A. The longitudinal direction is along direction Y, the lateral direction is along direction X, and the vertical direction is along direction Z. A Y-X plane can be considered to form a vertical plane. The vertical direction Z is normal to the vertical plane. A Y-Z plane can be considered to form a lateral plane. The lateral direction X is normal to the lateral plane. And an X-Z plane can be considered to form a longitudinal plane. The longitudinal direction Y is normal to the longitudinal plane.

Electric motor 12, drive 14, pump 19, frame 58, and fan assembly 134 are shown. Rotor 22, stator 20, and axle 23 of electric motor 12 are shown. Drive housing 110 is shown. Motor shroud 112 is disposed about the exterior of electric motor 12. Motor shroud 112 extends at least partially about rotor 22 and is disposed radially outward of rotor 22. Motor shroud 112 includes openings formed therethrough that allow cooling fluid to flow to and contact the exterior of rotor 22. Electric motor 12 is disposed within chamber 114.

Frame 58 supports other components of spray system 1. Drive housing 110 at least partially encloses various components of spray system 1. In the example shown, electric motor 12 is disposed at least partially within drive housing 110. In the example shown, electromagnetic components of electric motor 12 are disposed within drive housing 110. In the example shown, portions of drive housing 110 are formed by frame 58 and portions of drive housing 110 are formed are formed by case 116.

Pump 19 is configured to pump pressurized fluid, such as for spraying. Pump 19 can be configured as a reciprocating piston pump, among other options. Drive 14 is connected to electric motor 12 to receive a rotational output from electric motor 12. Drive 14 is connected to pump 19 to drive reciprocation of the reciprocating member (e.g., piston) of pump 19 to cause pumping by pump 19.

Case 116 is connected to frame 58. Case 116 is disposed at least partially around electric motor 12. Case 116 can be formed as a polymer housing, among other options. Case 116 can also be referred to as a shroud. In the example shown, case 116 and frame 58 together form drive housing 110.

In the example shown, at least a portion of frame 58 is disposed directly vertically below the electric motor 12. The portion of the frame 58 projects to radially overlap with electric motor 12 relative to motor axis A. The portion of the frame 58 can be configured such that that portion of the frame 58 projects axially beyond second end 26 of electric motor 12. The second end 26 can also be referred to as an unsupported end of electric motor 12. The first end 24 of electric motor 12 can also be referred to as a supported end or an output end as electric motor 12 outputs rotational motion through first end 24. Frame 58 can radially overlap with a full axial length of electric motor 12, in some examples.

Electric motor 12 is at least partially disposed within chamber 114. Chamber 114 is disposed within drive housing 110. The chamber 114 can be partially formed by the case 116. In the example shown, chamber 114 is at least partially defined by case 116 and frame 58. Chamber 114 can include a ceiling 118 and lateral walls 120a, 120b (collectively herein “lateral wall 120” or “lateral walls 120”) formed from the case 116. The chamber 114 can further be formed by longitudinal walls 122a, 122b (collectively herein “longitudinal wall 122” or “longitudinal walls 122”). Longitudinal walls 122a, 122b are spaced from each other along the motor axis A. Longitudinal wall 122a can also be referred to as a first wall or front wall of the chamber 114. Longitudinal wall 122b can also be referred to as a second wall or rear wall of the chamber 114. Longitudinal wall 122a can be formed from the frame 58. Longitudinal wall 122b can be formed from and/or include a heatsink 126. Pump 19 can be disposed on an opposite side of longitudinal wall 122a relative to electric motor 12.

In the example shown, chamber 114 is partially defined by frame 58 and partially defined by case 116. In the example shown longitudinal wall 122a and floor 124 are formed by frame 58. In the example shown, lateral walls 120a, 120b and ceiling 118 are formed by case. In the example shown, longitudinal wall 122b is formed by heatsink 126. Chamber 114 can be considered to be bounded by a first wall 122a, a second wall 122b, a pair of lateral walls 120a, 120b, a floor 124, and a ceiling 118. In the example shown, at least one wall defining the chamber 114 is formed as a heatsink.

Heatsink 126 is disposed directly between chamber 114 and control cavity 130. In the example shown, heatsink 126 is a metal structure comprising projections 128 (formed as fins or other structure) which project into the chamber 114. The projections 128 increase the surface area of the heatsink 126, improving a thermal transfer efficiency for cooling. Control cavity 130 is disposed within a control housing 132, which can be at least partially formed from frame 58, case 116, heatsink 126, etc. Controller 15 and other control elements can be disposed within control cavity 130. Control cavity 130 is spaced in second axial direction AD2 from chamber 114. Heatsink 126 is disposed directly between chamber 114 and control cavity 130 along motor axis A. In the example shown, a projection of motor axis A from electric motor 12 passes through heatsink 126 before passing through control cavity 130. Heatsink 126 can define a wall of both the chamber 114 and the control cavity 130. As shown, the fins of heatsink 126 project axially into chamber 114 and axially away from control cavity 130, relative to motor axis A.

Controller 15 is disposed within control cavity 130. One or more circuit boards of the controller 15 can be mounted directly to the wall of control cavity 130 that is formed by heatsink 126. In one example, controller 15 includes an insulated-gate bipolar transistor (IGBT). One or more components of controller 15 can be directly thermally connected to heatsink 126. For example, the one or more components can be directly mounted to the heatsink 126, can be connected to the heatsink 126 by a direct thermal pathway, etc. The IGBT can be thermally bonded to the circuit board that is mounted to or formed as part of the heatsink 126. The IGBT can be considered to form a control component of the controller 15.

Electric motor 12 is on one side of the longitudinal wall 122b and the control panel 13 is located on the opposite side of the longitudinal wall 122b from electric motor 12. Heat generated by the control panel 13 can conduct through the longitudinal wall 122b to be exposed to the cooling fluid within the chamber 114. In the example shown, the heat is conducted through heatsink 126 to the cooling fluid in chamber 114. In the example shown, heat generated by both the electric motor 12 and the control panel 13 can be dissipated by the cooling fluid flowing through chamber 114.

Fan assembly 134 is configured to blow cooling fluid through the cooling passages of drive system 10. Fan assembly 134 includes blade structure 136 that is configured to rotate on a fan axis FA to generate the flow of cooling air. In the example shown, blade structure 136 is formed with a plurality of blades that extend outward from a hub of the blade structure 136. The plurality of blades extend radially outwards from fan axis FA. Blade structure 136 can include one or more blades that rotate to move cooling fluid, such as air. Generally, the blade structure 136 rotates to pull air from underneath the fan assembly 134, in the example shown, and forces the air into the chamber 114 along pathway 146 through chamber 114. In the example shown, fan assembly 134 is exposed to atmosphere to draw air in from the environment around drive system 10, such air forming the cooling fluid. Fan assembly 134 is fluidly connected to the chamber 114 to blow the cooling air into chamber 114. Blade structure 136 is connected to fan motor 138. Fan motor 138 is configured to drive rotation of blade structure 136 to generate the flow of cooling air. Fan motor 138 can be an electric motor that is powered to generate the rotational motion of blade structure 136.

In the example shown, fan assembly 134 is mounted to frame 58. Fan assembly 134 is mounted on frame 58 to be supported by frame 58 independent of electric motor 12 and pump 19. The fan assembly 134 is separate from electric motor 12 and pump 19 such that operation of electric motor 12 or pump 19 does not directly mechanically operate fan assembly 134.Cooling fluid is flowed through the chamber 114 by fan assembly 134. In this embodiment, the fan assembly 134 is mounted to the frame 58. In particular, the frame 58 includes duct 148, but not all embodiments necessarily include a duct. The fan assembly 134 is mounted within the duct 148. Fan assembly 134 is disposed within duct 148. Duct 148 is formed through frame 58 in the example shown. Duct 148 is at least partially formed by frame 58. Duct 148 forms the cooling inlet 142 of the cooling circuit 140 of drive system 10. The cooling fluid enters into the cooling circuit 140 through cooling inlet 142. The cooling fluid flows into chamber 114 through cooling inlet 142.

The duct 148 projects vertically in the example shown. Duct 148 is oriented such that duct 148 opens to atmosphere in a vertically downward direction. Duct 148 opens to atmosphere in a direction away from electric motor 12. Duct 148 is oriented such that duct 148 opens to chamber 114 in a vertically upward direction. The duct 148 is open such that cooling fluid exiting from duct 148 and into chamber 114 flows towards electric motor 12. In the example shown, duct 148 is open radially outwards relative to the motor axis A such that a flow of cooling fluid generated by fan assembly 134 flows radially towards electric motor 12 relative to motor axis A. In the example shown, duct 148 is tubular. Duct 148 does not include turns or curvature that redirects the cooling fluid flow, in the example shown. In the example shown, the duct 148 is formed through the portion of frame 58 radially overlapping with electric motor 12. Duct 148 is disposed such that duct 148 radially overlaps with electric motor 12. The cooling fluid exits from cooling circuit 140 through cooling outlet 144. In the example shown, cooling outlet 144 is formed by vent 150. Vent 150 is formed through drive housing 110. In the example shown, vent 150 is formed through case 116. Vent 150 is shown as including multiple vent openings 142 through which cooling fluid can exit from the cooling circuit 140. The vent openings 142 are divided by housing ribs that can provide structural support to vent 150. In the example shown, vent 150 is disposed vertically above electric motor 12. Vent 150 is configured such that the cooling fluid rises vertically before being able to exit from cooling circuit 140. The position of vent 150 facilitates efficient cooling flow as heated air rises the heated air will rise towards vent 150 to be exhausted from cooling circuit 140. The fan assembly 134 is disposed vertically below the electric motor 12. In the example shown, fan assembly 134 is disposed directly vertically below the electric motor 12. Fan assembly 134 can be disposed directly vertically between the electric motor 12 and the ground surface. Fan assembly 134 is disposed such that fan assembly 134 radially overlaps with electric motor 12, relative to the motor axis A. Fan assembly 134 is disposed such that fan assembly 134 radially overlaps with rotor 22, relative to motor axis A. Fan assembly 134 is disposed such that fan assembly 134 radially overlaps with stator 20, relative to motor axis A. Fan assembly 134 is disposed such that fan assembly 134 radially overlaps with magnet array 34, relative to motor axis A.

Fan assembly 134 is configured to rotate on fan axis FA while rotor 22 of electric motor 12 is configured to rotate on motor axis A. In the example shown, fan assembly 134 is disposed such that the fan axis FA is non-coaxial with the motor axis A. Fan assembly 134 is disposed such that fan axis FA projects through one or both of the stator 20 and rotor 22 of the electric motor 12. In some examples, fan assembly 134 can be disposed such that fan axis FA is transverse to the motor axis A. In some examples, fan assembly 134 can be disposed such that fan axis FA is disposed orthogonal to the motor axis A.

The fan assembly 134 can be positioned such that fan axis FA is not parallel to the motor axis A. The fan assembly 134 is offset from electric motor 12 such that fan axis FA is not coaxial with motor axis A. In some examples, fan assembly 134 is disposed such that fan axis FA is transverse to motor axis A. In some examples, fan assembly 134 is disposed such that fan axis FA is orthogonal to motor axis A. In some examples, fan assembly 134 is disposed such that a first plane along which fan axis FA extends transverse to a second plane along which motor axis A extends. In some examples, the first plane can be disposed orthogonal to the second plane.

Rotor 22 rotates about a first axis (the motor axis A) and the blade structure 136 rotates about a second axis (the fan axis FA). The first axis can be disposed transverse to the second axis. The first axis can be orthogonal to the second axis. The first axis can be substantially horizontal, such as within 20-degrees of horizontal. The second axis can be substantially vertical, such as within 20-degrees of vertical. Other amounts of angular offset range are possible, such as within 5-degrees or 10-degrees of vertical or horizontal. In some examples, the first axis is orientated transverse to the second axis in a range of 85-95 degrees, or 80-100 degrees. In some examples, the second axis is orientated transverse to the first axis in a range of 85-95 degrees, or 80-100 degrees. In some examples, the first axis is horizontal and the second axis is vertical.

In the example shown, fan assembly 134 blows the cooling fluid through cooling circuit 140. Cooling circuit 140 extends between cooling inlet 142 and cooling outlet 144. Cooling fluid is configured to enter into cooling circuit 140 through cooling inlet 142, flows along pathway 146, and exits cooling circuit 140 as heated cooling fluid through cooling outlet 144. Pathway 146 is formed through chamber 114 in the example shown. The cooling fluid absorbs heat and increases in temperature as the cooling fluid flows through chamber 114 between cooling inlet 142 and cooling outlet 144.

The intake for the fan assembly 134 is located underneath the electric motor 12. The fan assembly 134 is disposed vertically below the electric motor 12. In this particular embodiment, the fan assembly 134 is located directly vertically below the electric motor 12. The fan assembly 134 is located below part of the frame 58 in the example shown. Fan assembly 134 is disposed vertically below electric motor 12 such that no portion of the fan assembly 134 is exposed from the top side of drive system 10. The fan assembly 134 is disposed such that fan assembly 134 is recessed longitudinally from longitudinal ends of drive system 10 and such that fan assembly 134 is recessed laterally from lateral sides of drive system 10. The fan assembly 134 is spaced in first axial direction AD1 from a rear longitudinal end of drive system 10. Fan assembly 134 is spaced in first axial direction AD1 from control panel 13. Fan assembly 134 is spaced in first axial direction AD1 from longitudinal wall 122b of chamber 114. Fan assembly 134 is spaced in second axial direction AD2 from longitudinal wall 122a of chamber 114. Fan assembly 134 is disposed laterally inward of the two lateral sides of the drive housing 110.

Being that the intake for the fan assembly 134 is located generally underneath a body of the drive system 10, atomized spray fluid in the environment around spray system 1 is unlikely to be pulled up into the fan assembly 134 and blown into the chamber 114. Generally during spraying, at least some particles of the paint, or other spray fluid, do not adhere to the surface being coated. Those particles, also referred to as “dry fall,” drift in the environment surrounding spray system 1 as the particles drift towards the ground. Such particles can remain wet, which causes the particles to adhere to surfaces if they do encounter any surfaces before reaching the ground. For example, if the particles are sucked into chamber 114, then such particles can adhere to blade structure 136, reducing the efficiency of fan assembly 134, can adhere to heatsink 126, reducing thermal transfer efficiency, etc. Generally, atomized spray fluid, if it is not adhered to the target surface, will fall downwards, such that the case 116 and frame 58 protects the intake of the fan assembly 134 from falling spray fluid. Positioning the fan assembly 134 on the vertically lower side of drive system 10 shields fan assembly 134 from the dry fall, inhibiting ingestion into chamber 114. Also, exhausting on the top side of the chamber 114 through vent 150 minimizes the risk of falling spray fluid from entering the vent 150 while air is blowing out of the vent 150.

Side rails 154 of frame 58 further partially close the intake for the fan assembly 134. Side rails 154 are formed as portions of frame 58. In the example shown side rails 154 are formed separately from other portions of frame 58 and connected thereto. It is understood, however, that side rails 154 can be formed monolithically with other portions frame 58. Side rails 154 project vertically downwards relative to floor 124 of chamber 114. Side rails 154 extend vertically downwards beyond fan assembly 134. In the example shown, fan assembly 134 is disposed axially between a lower side of side rails 154 (e.g., a portion closest to the ground surface) and electric motor 12. The side rails 154 partially enclose and protect the fan assembly 134 from falling spray fluid particles, further inhibiting ingestion. With side rails 154, fluid particles falling on the lateral sides of drive system 10 will need to travel vertically beyond siderails and then vertically upwards against gravity before reaching fan assembly 134.

Pump 19 is spaced from fan assembly 134 in first axial direction AD1. Pump 19 can axially overlap with fan assembly 134 relative to motor axis A. In the example shown, pump 19 radially overlaps with fan assembly 134 relative to fan axis FA. The pump 19 is disposed longitudinally forward of fan assembly 134. The pump 19 is positioned such that the pump housing 19a can inhibit dry fall from drifting longitudinally rearward towards fan assembly 134. As such, pump 19 can be considered to further protect cooling circuit 140 from ingestion of falling fluid particles.

Cooling circuit 140 extends from duct 148, through chamber 114, and to vent 150. The cooling fluid is drawn into cooling circuit 140 through duct 148 (forming cooling inlet 142) and is exhausted from cooling circuit 140 through vent 150 (forming cooling outlet 144). The pathway 146 along which cooling fluid can flow within chamber 114 extends around electric motor 12. In the example shown, the pathway 146 is exposed to both axial ends of the electric motor 12 and circumferentially about the electric motor 12. The pathway 146 extends fully about the motor axis A to extend fully circumferentially about electric motor 12 about the motor axis A, in the example shown. A portion of the pathway 146 is disposed directly axially between electric motor 12 and heatsink 126. At least a portion of the cooling fluid flows over the fins of heatsink 126 and draws heat from heatsink 126. The cooling fluid flows through chamber 114 and is exhausted through vent 150.

In the example shown, cooling circuit 140 is configured to intake cooling fluid at a location longitudinally rearward of pump 19. The cooling inlet 142 is spaced from pump 19 in second axial direction AD2 along motor axis A. The cooling circuit 140 intakes the cooling fluid at a location that is longitudinally forward of the controller 15. The cooling fluid moving through the chamber 114 collects heat from the electric motor 12 and the heatsink 126. The heated cooling fluid exhausts from chamber 114 through the one or more vents 150. Vent 150 is disposed longitudinally rearward of duct 148. Vent 150 can be formed in the case 116. The vent 150 is located vertically above the electric motor 12. The vent 150 is located on the top side of the chamber 114. As such, the fan assembly 134 generally pulls air from underneath the chamber 114 and the air is exhausted above the chamber 114.

In the example shown, the vent 150 is configured to exhaust the heated cooling fluid longitudinally away from pump 19. Vent 150 is oriented such that vent 150 exhausts the cooling fluid along the motor axis A and in axial direction AD2. The vent 150 is disposed radially outward of the motor axis A such that vent 150 exhausts the heated cooling fluid at a location radially outward of motor axis A. In the example shown, vent 150 is disposed radially outward of electric motor 12 such that the heated cooling fluid exits at a location radially outward of stator 20 and rotor 22. Having the vent 150 disposed radially outward of electric motor 12 facilitates cooling as the cooling fluid flows past a full vertical extent of the electric motor 12 before exiting through vent 150.

Vent 150 is disposed on an opposite radial side of electric motor 12 from the cooling inlet 142. Vent 150 is disposed on an opposite radial side of electric motor 12 from fan assembly 134. The vent 150 being disposed on an opposite radial side of electric motor 12 from fan assembly 134 encourages cooling as the cooling fluid flows vertically past electric motor 12 as the cooling fluid flows from duct 148 to vent 150. In some examples, the vent 150 is disposed at least about 120-degrees about the motor axis A from the cooling inlet 142. In some examples, the vent 150 is disposed between about 120-degrees and 180-degrees about the motor axis A from the cooling inlet 142. In some examples, the vent 150 is disposed at least about 120-degrees about the motor axis A from the fan assembly 134. In some examples, the vent 150 is disposed between about 120-degrees and 180-degrees, inclusive, about the motor axis A from the fan assembly 134.

In the example shown, drive system 10 includes a single vent 150 that is divided into multiple vent openings 142. The vent 150 is not disposed on a lateral side of the drive housing 110. The vent 150 is not disposed longitudinally forward of the electric motor 12. The vent 150 is not disposed on a front end of the drive housing 110. In the example shown, vent 150 is disposed at a longitudinally rear end of the chamber 114. The vent 150 is oriented to exhaust the heated air longitudinally rearward. The vent 150 is configured to exhaust the heated air away from electric motor 12. The vent 150 is open such that the heated air is exhausted in second axial direction AD2 out through vent 150. In some examples, vents 150 are further positioned such that the heated air is exhausted vertically upwards and away from electric motor 12. The vent 150 being positioned rearward of electric motor 12 and oriented to exhaust the heating cooling fluid further rearward can further assist in preventing falling spray particles from entering into the chamber 114.

The cooling circuit 140 is configured such that the cooling fluid moves longitudinally rearward between cooling inlet 142 and cooling outlet 144. The cooling fluid moves longitudinally rearward between the location at which the cooling fluid enters into chamber 114 and the location at which the cooling fluid exits from the chamber 114. The cooling fluid moves longitudinally away from pump 19 and towards control panel 13 as the cooling fluid flows from duct 148 to vent 150. The cooling fluid moves axially, relative to motor axis A, between duct 148 and vent 150. The cooling fluid flowing axially encourages flow over the axial length of electric motor 12, enhancing cooling as greater surface area is in a direct pathway between duct 148 and vent 150.

Heatsink 126 is spaced from electric motor 12 along motor axis A. In the example shown, heatsink 126 does not radially overlap with electric motor 12 along motor axis A. In the example shown, an axial gap 160 is formed between heatsink 126 and electric motor 12. In the example shown, heatsink 126 is spaced from electric motor 12 such that the electric motor 12 and heatsink 126 do not radially overlap with each other along the motor axis A. The axial gap 160 can be configured such that no structure of the electric motor 12 or heatsink 126 bridges the axial gap 160. The axial gap 160 between electric motor 12 and heatsink 126 is spaced longitudinally rearward of the fan assembly 134. The axial gap 160 between electric motor 12 and heatsink 126 is spaced in the same longitudinal direction from cooling inlet 142 as cooling outlet 144 is spaced from cooling inlet 142. The cooling pathway 146 is configured such that the cooling fluid can flow freely in the axial gap 160 between electric motor 12 and heatsink 126. In the example shown, a portion of the rotor extends into the frame 58. The cooling pathway 146 extends around that portion of the rotor and not axially between that portion of the rotor 22 and longitudinal wall 122a.

Heatsink 126 is disposed between the cooling inlet 142 and the cooling outlet 144. Heatsink 126 is disposed in the cooling pathway 146 downstream of cooling inlet 142 and upstream of cooling outlet 144. Heatsink 126 is disposed between duct 148 and vent 150. The cooling fluid flows over heatsink 126 as the cooling fluid flows from the duct 148 to vent 150. Heatsink 126 is disposed longitudinally rearward of cooling inlet 142. Heatsink 126 is spaced in second axial direction AD2 from duct 148 along motor axis A. Heatsink 126 is spaced from electric motor 12 along motor axis A in second axial direction AD2 and vent 150 is also spaced from electric motor 12 along motor axis A in second axial direction AD2. The cooling fluid flows longitudinally rearward from the duct 148 to the vent 150 with the vent 150 disposed longitudinally rearward of the duct 148. The heatsink 126 being spaced in the same longitudinal direction from duct 148 as vent 150 positions heatsink 126 such that the cooling fluid flows over heatsink 126 as the cooling fluid travels towards vent 150. Placing heatsink 126 in the direction of flow of the cooling fluid provides for improved thermal transfer efficiency as the cooling fluid is blown over heatsink 126 to travel to the cooling outlet 144. In some examples, heatsink 126 is disposed longitudinally between cooling inlet 142 and cooling outlet 144. In such an example, heatsink 126 can be spaced in second axial direction AD2 from duct 148 and in first axial direction AD1 from vent 150. In some examples, heatsink 126 is disposed to radially overlap with vent 150.

Heatsink 126 is disposed vertically between cooling inlet 142 and cooling outlet 144. Fan assembly 134 is positioned to blow the cooling fluid vertically upwards into chamber 114. The heatsink 126 is vertically upward of fan assembly 134 such that the fan assembly 134 actively blows air vertically. Vent 150 is disposed on an opposite vertical side of heatsink 126 from duct 148 such that the cooling fluid flows vertically past heatsink 126 prior to reaching vent 150. Such a configuration positions heatsink 126 so the cooling fluid flows over a full vertical extent of heatsink 126 prior to exiting through vent 150. The heatsink 126 being in the vertical gap between duct 148 and vent 150 provides efficient thermal transfer from heatsink 126 to the cooling fluid.

Heatsink 126 is disposed on an opposite axial side of electric motor 12 from drive 14. The heatsink 126 is disposed proximate second end 26 of electric motor 12. Heatsink 126 is disposed on an opposite end of electric motor 12 from the first end 24 that forms the output end of electric motor 12. The first end 24 of electric motor 12 outputs the rotational motion from electric motor 12. The heatsink 126 is disposed on an opposite axial end of the electric motor 12 form the end that the rotational motion is output from. In some examples, the electric motor 12 can be considered to be cantilevered from the frame 58 such that second end 26 is free and spaced from longitudinal wall 122b. The electric motor 12 is spaced from heatsink 126 such that air can flow freely between electric motor 12 and heatsink 126 in the axial gap 160 formed therebetween. Such a configuration allows for heatsink 126 to be formed as a plate and for increased surface area of heatsink 126 with electric motor 12 being spaced axially from heatsink 126 along motor axis A.

The heatsink 126 is disposed such that the cooling fluid is routed over the heatsink 126 as the cooling fluid flows from cooling inlet 142 to cooling outlet 144. The heatsink 126 is thermally connected to one or more components of controller 15 such that heat generated by controller 15 is wicked though heatsink 126 to the cooling fluid flow. The heatsink 126 provides cooling to controller 15.

In some examples, the heatsink 126 is directly thermally coupled to one or more components of controller 15. For example, a direct thermal pathway can be formed between the one or more components and heatsink 126. For example, components can be directly mounted to heatsink 126, such as by thermal interface materials (TIMs), or connected to heatsink 126 by a thermally conductive material extending between the component and heatsink 126. In one example, an IGBT can be thermally bonded to a printed circuit board mounted on the side of the heat exchanger oriented into the control cavity 130. The heatsink 126 forming a wall of the control cavity 130 encourages thermal transfer from control cavity 130 to chamber 114, facilitating cooling of controller 15.

The cooling circuit 140 provides cooling to electric motor 12 and controller 15. Controller 15 is located on an opposite side of longitudinal wall 122b from electric motor 12. Heatsink 126 is disposed directly between electric motor 12 and controller 15. The cooling airflow flows directly over electric motor 12. The cooling airflow can directly receive heat generated by electric motor 12 and transfer that heat out of chamber 114 through vent 150. The cooling airflow flows directly over longitudinal wall 122b to absorb heat from longitudinal wall 122b. Longitudinal wall 122b includes thermally conductive material that passes heat to the cooling airflow. In the example shown, the thermally conductive material is formed by heatsink 126. In some examples, the thermally conductive material can be a metal, among other options.

The cooling airflow can indirectly cool controller 15 by absorbing heat thermally transferred from controller 15 to the cooling airflow through heatsink 126. The single cooling airflow through cooling circuit 140 provides cooling to multiple heat generating components. The multiple heat generating components that are cooled by the single airflow output by fan assembly 134 are disposed in separate chambers (e.g., chamber 114 and control cavity 130). The fan assembly 134 is configured to actively blow the cooling fluid through a single one of those separate chambers. In some examples, chamber 114 and control cavity 130 are sealed compartments. In some examples, one or both of chamber 114 and control cavity 130 includes small openings or gaps that may allow some cooling airflow to escape, but vent 150 is still configured to eject the heated cooling fluid. In the example shown, the chamber 114 and control cavity 130 are separated from each other by longitudinal wall 122b such that the cooling fluid is actively flowed through chamber 114 but not control cavity 130. Control cavity 130 can be considered to be isolated from the cooling fluid flow output by fan assembly 134.

Fan assembly 134 is mounted independently of the pump 19 and the electric motor 12. In particular, the fan assembly 134 is mounted to the frame 58 independently of the pump 19 and the electric motor 12 also being mounted to the frame 58 such that one can be taken off without taking off the other. The fan assembly 134 is not mounted to the electric motor 12 or otherwise structurally supported by the electric motor 12. Fan assembly 134 is not mechanically connected to the electric motor 12 to be driven by the electric motor 12. The fan motor 138 is separate from any mechanical driving output from electric motor 12. Blade structure 136 is not forced to rotate to drive air into chamber 114 by rotation of electric motor 12. Instead, the fan assembly 134 is separate from the electric motor 12 such that blade structure 136 can be caused to rotate separately from the rotor 22 rotating. The blade structure 136 can be caused to rotate while rotor 22 is stationary or while rotor 22 is spinning. The blade structure 136 can be rotated at different rotational speeds from rotor 22 or the same rotational speed as rotor 22 while both blade structure 136 and rotor 22 are spinning.

Operation of the fan assembly 134 refers to causing the blade structure 136, via an electric fan motor 138 of the fan assembly 134, to rotate sufficient to move air. The blade structure 136 is actively rotated by the fan motor 138 during operation of fan assembly 134. The fan assembly 134 includes an electric fan motor 138 that spins the blade structure 136 on fan axis FA. The electric fan motor 138 can be operated independently of the electric motor 12. More specifically, the electric motor 12 can be operated to spin the rotor 22 without spinning the electric fan motor 138 or the blade structure 136. The electric fan motor 138 of the fan assembly 134 can be any type of electric motor. The electric fan motor 138 can be controlled by controller 15 or other control circuitry. In some examples, controller 15 is considered to include fan control circuitry that controls operation of fan assembly 134 and controller 15 can be further considered to include motor control circuitry that controls operation of electric motor 12, thereby controlling pumping by pump 19.

In some examples, the fan motor 138 is controlled to spin based on an operating condition of electric motor 12. In some examples, controller 15 operates fan assembly 134 to output the flow of cooling fluid based on whether rotor 22 is being controlled to rotate. In some examples, controller 15 operates fan assembly 134 to output the flow of cooling fluid such that the fan assembly 134 is not operated to output the flow of cooling fluid when the electric motor 12 is not operating the pump 19.

For example, the electric fan motor 138 can be controlled to spin only when the rotor 22 of the electric motor 12 is driven to spin, though it is understood that not all examples are so limited. Such a configuration can minimize the noise made by the fan assembly 134, which is otherwise drowned out by the noise of the electric motor 12. Operating the electric fan motor 138 only when the electric motor 12 is operating can result in the fan assembly 134 being operationally unnoticeable, whereas operating the electric fan motor 138 and blowing air while the electric motor 12 is not operating, during which condition the operator may assume that the spray system 1 should not be doing anything, avoids operating noticeable functions on board the spray system 1 when the user would expect no obvious operation, providing increased user confidence in spray system 1.

Fan assembly 134 can be controlled to operate based on operating parameters of the spray system 1. In some examples, fan assembly 134 is controlled to operate based on a sensed temperature of one or more components of drive system 10. As discussed in more detail below, fan assembly 134 can be operated when a sensed temperature satisfies a thermal threshold. The fan assembly 134 can be deactivated and not operated when the sensed temperature does not satisfy the thermal threshold. In some examples, fan assembly 134 is controlled to operate based on an operating state of electric motor 12. For example, fan assembly 134 can be caused to rotate only when rotor 22 is spinning.

In some examples, the controller 15 can vary the speed of the fan assembly 134 based on the operating parameters. Controller 15 can vary the speed of the fan assembly 134 based on a sensed temperature. For example, fan assembly 134 can be caused to spin more quickly based on higher sensed temperatures. Additionally or alternatively, controller 15 can vary the speed of fan assembly 134 based on a rotational speed of rotor 22. For example, fan assembly 134 can be caused to spin more quickly based on a greater rotational speed of rotor 22.

In some examples, the controller 15 is configured to control operation of the fan assembly 134 based on multiple triggering thresholds. For example, the controller 15 can operate the fan assembly 134 in a first operating mode based on a sensed temperature not satisfying a lower threshold. The controller 15 can operate the fan assembly 134 in a second operating mode based on the sensed temperature satisfying the lower threshold. The controller 15 can operate the fan assembly 134 in a third operating mode based on the sensed temperature satisfying a higher threshold. It is understood that a parameter can satisfy a threshold by exceeding the threshold or by meeting or exceeding the threshold.

In some examples, controller 15 can be configured to operate fan assembly 134 based on each of multiple operating parameters being true. For example, controller 15 can be configured to control operation of fan assembly 134 based on sensed temperature and operation of electric motor 12. In one example, controller 15 is configured to cause fan assembly 134 to operate based on the sensed temperature satisfying a threshold and the electric motor 12 being powered to spin. In such an example, controller 15 will activate fan assembly 134 only if both conditions are met. It is understood that, in some examples, the electric motor 12 can be powered to spin while rotor 22 remains stationary. For example, the electric motor 12 can be powered to spin while a valve of the spray gun 5 is closed preventing release of the spray fluid. In such a case, the electric motor 12 can urge to maintain pressure in supply line 4 for the next activation of spray gun 5 for spraying. It is understood that, in other examples, controller 15 can control operation of fan assembly 134 based on whether rotor 22 is actually moving.

Drive system 10 with active cooling provides significant advantages. Fan assembly 134 is separate from electric motor 12 and is individually controllable. Fan assembly 134 can be operated to blow cooling fluid through chamber 114 regardless of the operating state of electric motor 12. Fan assembly 134 being separately operable from electric motor 12 allows fan assembly 134 to be controlled to provide tailored cooling to drive system 10. Energy is conserved and wear is reduced by running fan assembly 134 when cooling is actually needed, not simply based on electric motor 12 operating.

Fan assembly 134 is disposed vertically below electric motor 12. Fan assembly 134 is disposed such that fan assembly 134 and electric motor 12 axially overlap along the fan axis FA. The fan axis FA extends vertically through electric motor 12. Fan assembly 134 is further disposed such that fan assembly 134 and electric motor 12 radially overlap along the motor axis A. Fan assembly 134 is disposed on a vertically lower side of drive system 10. Fan assembly 134 being disposed vertically below chamber 114 that fan assembly 134 blows cooling fluid into protects fan assembly 134 from falling spray particles. The fan assembly 134 is shielded vertically by drive housing 110 and electric motor 12 and is shielded laterally by side rails 154. Shielding fan assembly 134 inhibits spray particles from drifting to fan assembly 134 and being ingested into chamber 114, preventing internal components from being coated by the spray particles.

Vent 150 is disposed vertically above electric motor 12. Vent 150 is disposed on a top side of chamber 114 such that the heated air is exhausted from the top side of drive system 10. Having vent 150 disposed on a top side of drive system 10 encourages exhaust from chamber 114 as the heated air within chamber 114 will rise vertically towards vent 150. Further, vent 150 is disposed on an opposite side of chamber 114 from duct 148, encouraging cooling air to flow through chamber 114 and over electric motor 12 and heatsink 126, providing efficient cooling.

Heatsink 126 extends into chamber 114 and is disposed within the cooling airflow through chamber 114. Heatsink 126 is positioned to wick heat from the control cavity 130 to provide cooling to controller 15 and other components within control cavity 130. The heatsink 126 is spaced axially along motor axis A from electric motor 12, providing a flowpath for cooling air to flow directly between electric motor 12 and heatsink 126. Heatsink 126 is disposed between duct 148 and vent 150 such that the cooling air flows vertically by heatsink 126 between duct 148 and vent 150. Heatsink 126 is disposed longitudinally rearward of duct 148. Heatsink 126 is spaced in the same direction from duct 148 (axial direction AD2) as vent 150. Positioning of the heatsink 126 encourages cooling airflow over heatsink 126 and facilitates efficient cooling.

Cooling circuit 140 provides cooling for multiple components disposed in different chambers. Cooling circuit 140 extends around electric motor 12 such that electric motor 12 is directly exposed to the cooling airflow. Heatsink 126 is directly exposed to the cooling airflow. Heatsink 126 provides thermal transfer from control cavity 130 that is separate from the chamber 114 that forms a portion of the cooling circuit 140. The cooling circuit 140 providing cooling to components exposed directly to the airflow and components compartmentally separated from the cooling airflow provides for efficient cooling while inhibiting residency of heated air and allowing for use of a smaller, more efficient fan assembly 134 to provide adequate airflow.

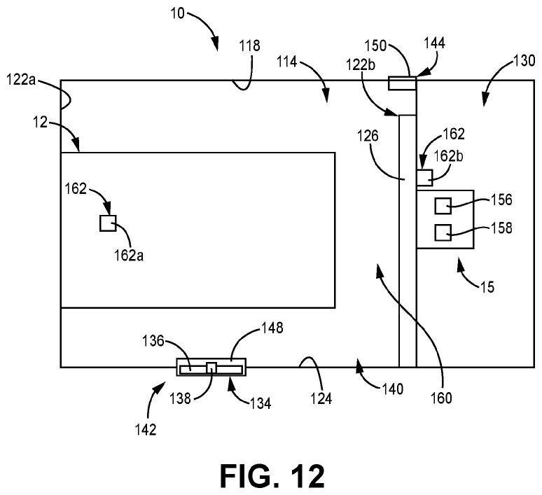

FIG. 12 is a schematic block diagram of drive system 10. Electric motor 12, drive housing 110, controller 15, heatsink 126, and fan assembly 134 are shown. Cooling inlet 142, cooling outlet 144, and pathway 146 of cooling circuit 140 are shown. Sensors 162a, 162b (collectively herein “sensor” or “sensors”) are shown.

Drive system 10 is configured to generate a mechanical driving output to power pumping by a pump, such as pump 19. Electric motor 12 is an electric motor. Electric motor 12 includes a rotor, similar to rotor 22, configured to rotate on motor axis A. Electric motor 12 includes a stator, similar to stator 20, configured to generate electromagnetic signals to drive rotation of rotor 22. Electric motor 12 is disposed within chamber 114 that is at least partially defined by drive housing 110. Heatsink 126 at least partially defines chamber 114 in the example shown. Electric motor 12 is disposed within cooling circuit 140. Electric motor 12 is disposed within chamber 114 such that an exterior of electric motor 12 is directly exposed to the cooling fluid flowing through chamber 114.

Controller 15 can be of any desired configuration for controlling pumping by displacement pump 19 and can include control circuitry and memory. Controller 15 is configured to store software, store executable code, implement functionality, and/or process instructions. Controller 15 is configured to perform any of the functions discussed herein, including receiving an output from any sensor referenced herein, detecting any condition or event referenced herein, and controlling operation of any components referenced herein. Controller 15 is configured to control operation of electric motor 12 and fan assembly 134. Controller 15 controls operation of electric motor 12 to control pumping by the pump 19. Controller 15 controls operation of fan assembly 134 to control provision of cooling fluid to drive system 10. In the example shown, controller 15 is shown as including motor control circuitry 156 configured to control operation of electric motor 12 and to include fan control circuitry 158 configured to control operation of fan assembly 134. The motor control circuitry 156 can also be referred to as a motor controller. The fan control circuitry 158 can also be referred to as a fan controller. It is understood that motor control circuitry 156 and fan control circuitry 158 can be mounted on the same or across one or more circuit boards.

Controller 15 is disposed within control cavity 130 of control panel 13. In the example shown, control cavity 130 is fluidly disconnected from chamber 114 such that no direct fluid pathway extends between control cavity 130 and chamber 114. It is understood, however, that not all examples are so limited. For example, cooling circuit 140 can be configured such that cooling fluid blown by fan assembly 134 flows within both chamber 114 and control cavity 130.

Heatsink 126 is disposed between chamber 114 and control cavity 130. Heatsink 126 forms at least a portion of the longitudinal wall 122b. Longitudinal wall 122b is disposed between chamber 114 and control cavity 130. Longitudinal wall 122b can be considered to form a rear wall of chamber 114 and a forward wall of control cavity 130.

Heatsink 126 is exposed to the cooling fluid flowing through chamber 114. In the example shown, one or more components of controller 15 are mounted directly to heatsink 126. For example, a printed circuit board supporting one or more components of controller 15 can be mounted directly to heatsink 126. In some examples, a thermal interface material (TIM) can adhere one or more components of controller 15 to heatsink 126. The components of controller 15 thermally mounted to heatsink 126 are not directly exposed to the cooling fluid flow in the example shown. Instead, such components are thermally connected to the cooling fluid flow via heatsink 126.

Fan assembly 134 is configured to blow cooling air through cooling circuit 140. Fan assembly 134 is mounted to draw cooling air into cooling circuit 140 through cooling inlet 142 and to drive cooling air through cooling circuit 140 and out through cooling outlet 144. Fan assembly 134 can be a variable speed assembly in which blade structure 136 can be caused to rotate at different speeds, though it is understood that not all examples are so limited. For example, fan assembly 134 can be configured to operate at a single rotational speed or at multiple rotational speeds.

Sensors 162 are configured to generate information regarding an operating condition of drive system 10. In the example shown, sensors 162 are formed as temperature sensors. The temperature information generated by one or more of sensors 162 can be utilized to control operation of fan assembly 134, as discussed in more detail below. While drive system 10 is shown as including multiple temperature sensors 162, it is understood that not all examples are so limited. For example, fan assembly 134 can be controlled based on temperature information from a single temperature sensor or based on operation or electric motor 12 without input from a sensor 162.

Sensor 162a is operatively associated with electric motor 12. Sensor 162a is configured to generate information regarding a temperature of electric motor 12. In some examples, sensor 162a can be considered to form a motor sensor. In some examples, sensor 162a can be mounted to a circuit board within electric motor 12. In some examples, sensor 162a can be disposed proximate an encoder of electric motor 12. In some examples, sensor 162a is mounted within chamber 114 proximate to electric motor 12 but outside of electric motor 12. In some examples, sensor 162a is disposed radially within stator 20 of the electric motor 12. The sensor 162a can be disposed radially inward of the rotor 22.

Sensor 162b is operatively associated with controller 15. Sensor 162b is configured to generate information regarding a temperature of controller 15. In some examples, sensor 162b is configured to generate information regarding the temperature of a component of controller 15. For example, sensor 162b can be configured to generate information regarding the temperature of an IGBT of controller 15.

The one or more temperature sensors 162 can be provided as part of the controller 15, within the electric motor 12, within the chamber 114, and/or elsewhere as part of the spray system 1. Data generated by the one or more temperature sensors 162 can be part of the control algorithm for operating the fan assembly 134. In some examples, the fan assembly 134 may only be operated when the temperature sensor 162 senses a temperature above a threshold. As such, the fan assembly 134 may only be operated for cooling as actually needed, such that even if the electric motor 12 is operating the fan assembly 134 may not operate so long as the sensed temperature remains below the threshold.

Fan assembly 134 is operated based on operating conditions of the drive system 10. The rotational speed of fan assembly 134 can be varied based on the operating conditions. For example, fan assembly 134 can be operated at different speeds depending on the cooling needs. The controller 15 can be configured to cause fan assembly 134 to operate at a first speed based on the sensed temperature satisfying a first temperature threshold. The controller 15 can be configured to cause fan assembly 134 to operate at a second speed different from the first speed based on the sensed temperature satisfying a second temperature threshold. For example, the controller 15 can cause the fan assembly 134 to operate at the first speed based on the sensed temperature satisfying a first temperature threshold (e.g., lower thermal threshold) and can then cause the fan assembly 134 to operate at a second, higher speed based on the sensed temperature satisfying a second temperature threshold (e.g., upper thermal threshold) higher than the first temperature threshold. It is understood that fan assembly 134 can be operated based on one, two, or more than two temperature thresholds. For example, the fan assembly 134 can be caused to operate at yet a third speed greater than the first and second speeds based on the sensed temperature satisfying a third temperature threshold higher than the first and second temperature thresholds.

Controller 15 can additionally or alternatively be configured to control a speed of fan assembly 134 based on the rotational speed of electric motor 12. The speed of fan assembly 134 can vary with variations in speed of the electric motor 12. For example, the controller 15 can cause the fan assembly 134 to operate at a relatively higher speed when the rotor 22 is spinning at a relatively higher speed. The controller 15 can similarly cause the fan assembly 134 to operate at a relatively lower speed when the rotor 22 is spinning at a relatively lower speed.

In some examples, controller 15 is configured to control operation of fan assembly 134 based on speed thresholds of the electric motor 12. The speed threshold can be set based on a rotational speed of the rotor 22, such as based on the speed reaching or exceeding certain revolutions per minute (RPM) thresholds. Controller 15 can cause the fan assembly 134 to operate at a first speed based on the speed of the electric motor 12 meeting a first speed threshold and can cause fan assembly 134 to operate at a second speed based on the speed of electric motor 12 meeting a second speed threshold. For example, the first speed of fan assembly 134 can be less than the second speed of fan assembly 134 based on the second speed threshold being greater than the first speed threshold. It is understood that the speeds of the fan assembly 134 can be zero. For example, the controller 15 can deactivate the fan assembly 134 such that the speed of fan assembly 134 is zero based on the motor speed being less than the first threshold.

In some examples, controller 15 is configured to actively control the speed of fan assembly 134 by ramping the speed based on operating conditions of drive system 10. For example, the controller 15 can be configured to ramp the speed of fan assembly 134 based on sensed temperature. The controller 15 can cause the fan assembly 134 to operate at a first speed based on a first temperature threshold being satisfied by a sensed temperature. The controller 15 can then cause the fan assembly 134 to accelerate across various speeds as the temperature rises. Such ramping can continue until the fan assembly 134 is operating at 100% of fan speed. The controller 15 can be configured such that fan assembly 134 reaches 100% fan speed at a second temperature threshold greater than the first temperature threshold.

In some examples, the fan control circuitry operates the fan assembly 134 to output the flow of cooling fluid based on two conditions both being met: (1) when the electric motor is powered to operate the pump, and (2) a sensed temperature onboard the fluid sprayer is above a temperature threshold.

In some examples, controller 15 is configured to control operation of fan assembly 134 based on multiple conditions being satisfied. In some examples, at least two conditions must be met to cause operation of the fan assembly 134. In some examples, those two conditions include sensed temperature above the threshold and concurrent operation of the electric motor 12. If either those conditions fail to be met, then the fan assembly 134 may not begin to operate (until eventually met), or if operating when the loss of condition is identified, then the fan assembly 134 may be disengaged until both conditions are again met. In such an example, the controller 15 can cause the fan assembly 134 to operate based both on a temperature condition and a motor speed condition. The controller 15 will cause the fan assembly 134 to operate only in the event that each of the baseline conditions are true. For example, if the motor speed condition is not met (e.g., the motor speed is below a speed threshold) then controller 15 will not cause fan assembly 134 to operate even if the temperature condition is satisfied (e.g., sensed temperature is greater than a temperature threshold or sensed temperature is greater than or equal to a temperature threshold). Similarly, if the motor speed condition is met but the temperature condition is not met, then controller 15 will not cause fan assembly 134 to operate.

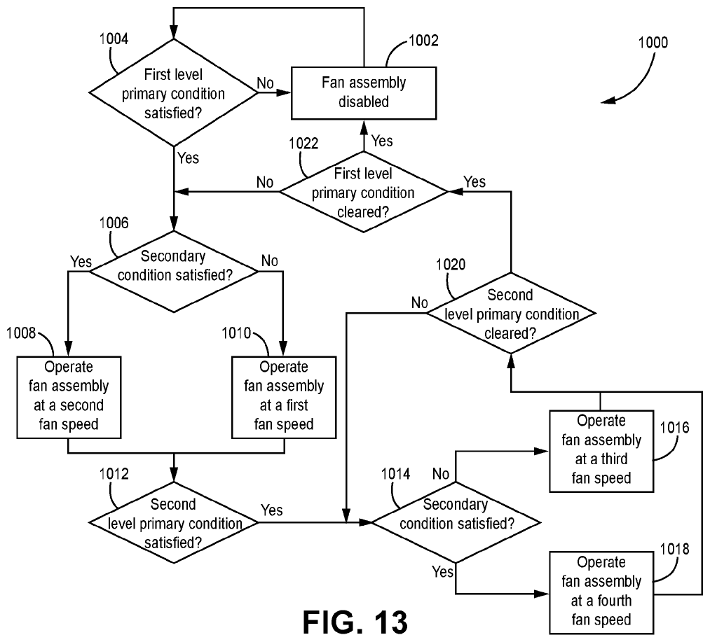

FIG. 13 is a flowchart showing an example control routine 1000 for active cooling of drive system 10. In the example discussed, fan assembly 134 is initially disabled and not operating to generate the flow of cooling fluid, at step 1002. At step 1004, controller 15 checks to determine if a first level primary condition is satisfied. The primary condition can be an operating condition of the drive system 10. The primary condition can be based on a temperature threshold related to one or more components of drive system 10. For example, the primary condition can be a lower thermal threshold compared to a sensed motor temperature and/or a lower thermal threshold compared to a sensed controller temperature. The controller 15 can compare the sensed temperature to a temperature threshold to determine if the primary condition is satisfied. In some examples, the sensed temperature satisfies the thermal threshold by meeting or exceeding the thermal threshold. In some examples, the sensed temperature satisfies the thermal threshold by exceeding the thermal threshold.

The primary conditions can further include other thermal conditions, such as a thermal alarm being in an activated state and/or electric motor 12 being operated in a reduced power mode, etc. Electric motor 12 can be operated in a reduced power mode in which controller 15 limits electric current flow to electric motor 12 to limit heat generation. Controller 15 can operate electric motor 12 in the reduced-power configuration based on sensed temperature, power draw of electric motor 12, among other considerations. The primary condition can be based on an operating state of the electric motor 12, such as whether the motor is rotating.

Different levels of primary conditions can be associated with different primary conditions. For example, a first level of primary conditions can include temperature thresholds while a second level of primary conditions can include temperature thresholds, alarm statuses, motor operating mode, etc. In one example, the first level primary conditions can include lower thermal thresholds and the second level primary conditions can include upper thermal thresholds. It is understood that any condition satisfying a second level of primary conditions can be considered as also satisfying the first level of primary conditions.

If the first level primary condition is not satisfied, then control routine 1000 returns to step 1002 and fan assembly 134 remains deactivated. With no first level primary condition satisfied, controller 15 can be considered to be operating fan assembly 134 in a first operating mode. If the first level primary condition is satisfied (e.g., a sensed temperature satisfies a lower temperature threshold), then control routine 1000 proceeds to step 1006. With the first level primary condition satisfied, the controller 15 can be considered to operate the fan assembly 134 in a second operating mode.

At step 1006, controller 15 determines whether a secondary condition is satisfied. If the secondary condition is not satisfied, then control routine 1000 moves to step 1008 and the fan assembly 134 is operated at a first fan speed. If the secondary condition is satisfied, then control routine 1000 moves to step 1010 and fan assembly 134 is operated at a second fan speed. It is understood that, in some examples, the first fan speed is the same as the second fan speed. In other examples, the first fan speed differs from the second fan speed.

In some examples, the secondary condition can be required for operating fan assembly 134. In such an example, the first fan speed can be zero such that fan assembly 134 is disabled. Controller 15 can thus be configured such that fan assembly 134 is disabled unless both the primary and secondary conditions are satisfied. For example, the secondary condition can be the motor being powered to spin. If the electric motor 12 is not being powered, then the secondary condition is not satisfied and fan assembly 134 remains disabled. In another example, the secondary condition can be the rotor 22 actually spinning. If rotor 22 is not spinning, then the secondary condition is not satisfied and fan assembly 134 remains disabled.

In some examples, the primary condition controls whether fan assembly 134 is powered to generate the cooling fluid flow and the secondary condition controls the rotational speed of fan assembly 134. For example, the secondary condition can be a speed threshold for rotor 22 of electric motor 12 (e.g., revolutions per minute (RPM)). If the speed threshold is satisfied (such as by rotor 22 exceeding the speed threshold or by rotor 22 meeting or exceeding the speed threshold), then fan assembly 134 is operated at the second fan speed. If the speed threshold is not satisfied, then fan assembly 134 is operated at the first fan speed. The first fan speed can be less than the second fan speed, which provides cooling while also reducing the noise level generated by fan assembly 134 to coincide with slower rotor 22 movement. For example, the first fan speed can be about 20%, 30%, 40%, 50%, or more or less than a full operational speed of fan assembly 134. The second fan speed can be about 70%, 80%, 90%, 100% or less than the full operational speed of fan assembly 134.

Control routine 1000 moves to step 1012 and determines if a second level primary condition is satisfied. If the second level primary condition is not satisfied, then control routine 1000 moves to step 1022 and determines if the first level primary condition has been cleared. In some examples, a primary condition is cleared by the primary condition no longer satisfying an associated threshold. For example, a sensed motor temperature can fall to a lower motor temperature threshold (or below the lower motor temperature threshold in examples in which the threshold is satisfied by being met or exceeded) such that the primary condition is no longer satisfied. In some examples, controller 15 can be configured to implement a trigger point offset (i.e., hysteresis) when clearing a primary condition. The trigger point offset facilitates effective cooling and prevents fan assembly 134 from oscillating between activated and deactivated based on minor variations in temperature, which quick oscillation can increase wear on fan assembly 134. The trigger point offset involves the controller 15 clearing the primary condition based on the sensed state of the primary condition clearing an associated threshold by an offset value. For example, the sensed temperature falling to the thermal threshold and then further below by an offset value measured in degrees. For example, the thermal threshold value can be “X” (e.g., 75-degrees, 90-degrees, 100-degress, etc.) and the offset value can be “Y” (e.g., 2-degrees, 3-degrees, 5-degrees, etc.) in which case the primary condition is triggered to cause controller 15 to advance to step 1006 based on the sensed thermal parameter reaching thermal value X and the controller 15 clears that primary condition based on the sensed thermal parameter reaching thermal value (X-Y). For example, a thermal threshold of 95-degrees (value X) and an offset value of 2-degrees (value Y) results in a clearance threshold of 93-degrees. The controller 15 can consider the primary condition cleared based on the sensed parameter reaching the clearance threshold. It is understood that controller 15 can implement thermal offsets of different values as between different condition levels. For example, a first offset value can be associated with clearing a first level primary condition and a different offset value can be associated with clearing a second level primary condition.

If the second level primary condition is satisfied, such as by a sensed temperature satisfying an upper thermal threshold, a thermal alarm being active, motor being operated in the reduced power mode, etc., then control routine 1000 advances to step 1014. The second level primary condition being satisfied can be considered to cause controller 15 to operate fan assembly 134 in a third operating mode.

At step 1014, controller 15 determines whether a secondary condition is satisfied. If the secondary condition is not satisfied, then control routine 1000 moves to step 1016 and the fan assembly 134 is operated at a third fan speed. If the secondary condition is satisfied, then control routine 1000 moves to step 1018 and fan assembly 134 is operated at a fourth fan speed. It is understood that, in some examples, the third fan speed is the same as the fourth fan speed. In other examples, the third fan speed differs from the fourth fan speed. In some examples, the third fan speed is the same as the first fan speed and/or the second fan speed. In some examples, the fourth fan speed is the same as the first fan speed and/or the second fan speed.

The secondary condition analyzed at step 1014 can be the same as or different from the secondary condition analyzed at step 1006. In some examples, the third fan speed can be zero. In some examples, the secondary condition can be a speed threshold for rotor 22 of electric motor 12 (e.g., revolutions per minute (RPM)). If the speed threshold is satisfied (such as by rotor 22 exceeding the speed threshold or by rotor 22 meeting or exceeding the speed threshold), then fan assembly 134 is operated at the fourth fan speed. If the speed threshold is not satisfied, then fan assembly 134 is operated at the first third speed. In some examples, the third fan speed is the same as the fourth fan speed such that the secondary condition does not affect fan speed with controller 15 controlling fan assembly 134 in the third operating mode.

Control routine 1000 proceeds to step 1020 with the fan assembly 134 operating at either the third fan speed or the fourth fan speed. At step 1020, controller 15 determines whether the second level primary conditions are cleared. The second level primary conditions can be cleared similar to the first level primary conditions. For example, the second level primary condition can reach an associated threshold or fall below the associated threshold by an offset value. In some examples, the second level primary condition requires active clearance. For example, if a thermal alarm is triggered, the thermal alarm can remain active until cleared by the user (e.g., by interfacing with user interface 17, depowering spray system 1, etc.).

If the second level primary condition is not cleared, then controller 15 continues to control operation of fan assembly 134 in the third operating mode. If the second level primary conditions are cleared, then control routine 1000 moves to step 1022 and determines if the first level primary conditions are cleared. If the first level primary conditions are not cleared, then controller 15 moves to step 1006 and determines the secondary condition status and controller 15 controls operation of fan assembly 134 in the second operating mode. If the first level primary conditions are cleared, then control routine 1000 moves to step 1002 and controller 15 reverts to controlling operation of fan assembly 134 in the first operating mode.

Control routine 1000 provides significant advantages. Operating fan assembly 134 to generate the cooling fluid flow based on the operating conditions of drive system 10 causes fan assembly 134 to operate only when cooling is actively required. Operating fan assembly 134 when cooling is required reduces wear on fan assembly 134, increasing operational lifespan and decreasing time and maintenance costs. Operating fan assembly 134 based on multiple levels of primary conditions tailors fan assembly 134 operation to the actual conditions experienced by drive system 10. The fan assembly 134 can be operated at lower speeds when lesser amounts of cooling are required and can be operated at higher speeds to generate greater flow of cooling fluid when greater amounts of cooling are required. Tailoring fan assembly 134 operation to the actual operating conditions reduces wear on fan assembly 134 while providing desired cooling.

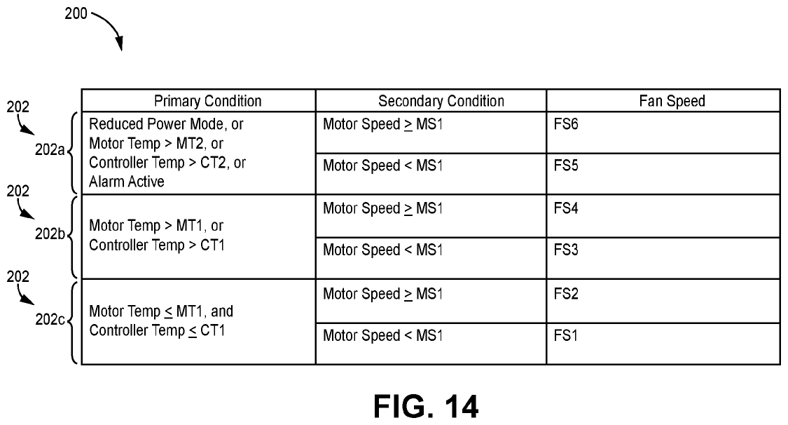

Control table 200 is shown in FIG. 14. Control table 200 is one non-limiting example of a control scheme for operation of fan assembly 134. Control table 200 includes three control levels 202a-202c (collectively herein “control level 202” or “control levels 202”) of primary operating conditions for operating fan assembly 134. Control level 202a can be referred to as a first control level, control level 202b can be referred to as a second control level, and control level 202c can be referred to as a third control level. Controller 15 can be considered to operate fan assembly 134 in a first operating mode in control level 202a, to operate in a second operating mode in control level 202b, and to operate in a third operating mode in control level 202c.

In the example shown in FIG. 14, the at least some of the primary conditions are based on sensed temperatures of different components of drive system 10. At control level 202a, the primary conditions are motor temperature, such as based on temperature data from sensor 162a, and control temperature, such as based on temperature data from sensor 162b. For example, the control temperature can be based on the sensed temperature of the IGBT of the controller 15. In the example shown, the motor temperature threshold differs from the control temperature threshold and either temperature threshold can trigger activation of fan assembly 134.

In the example shown, motor temperature is associated with lower threshold MT1 and upper threshold MT2. Lower threshold MT1 is a lower temperature than upper threshold MT2. Lower threshold MT1 can be associated with a temperature of about 95-degrees C. (about 200-degrees F.). Upper threshold MT2 can be associated with a temperature of about 110-degrees C. (about 230-degrees F.). Upper threshold MT2 can be about 10-20% greater than lower threshold MT1. In some examples, upper threshold MT2 is about 13-17% greater than lower threshold MT1. In some examples, upper threshold MT2 is about 15% greater than lower threshold MT1. Lower threshold MT1 is configured as a lower level primary condition (e.g., a first level primary condition as discussed with regard to FIG. 13) in the example shown and upper threshold MT2 is configured as an upper level primary condition (e.g., a second level primary condition as discussed with regard to FIG. 13) in the example shown. Lower threshold MT1 can also be referred to as a first lower threshold. Upper threshold MT2 can also be referred to as a first upper threshold.

In the example shown, control temperature is associated with lower threshold CT1 and upper threshold CT2. Lower threshold CT1 is a lower temperature than upper threshold CT2. Lower threshold CT1 can be associated with a temperature of about 75-degrees C. (about 167-degrees F.). Upper threshold CT2 can be associated with a temperature of about 90-degrees C. (about 194-degrees F.). Upper threshold CT2 can be about 15-25% greater than lower threshold CT1. In some examples, upper threshold CT2 is about 20% greater than lower threshold CT1. Lower threshold CT1 is configured as a lower level primary condition (e.g., a first level primary condition as discussed with regard to FIG. 13) in the example shown and upper threshold CT2 is configured as an upper level primary condition (e.g., a second level primary condition as discussed with regard to FIG. 13) in the example shown. Lower threshold CT1 can also be referred to as a second lower threshold. Upper threshold CT2 can also be referred to as a second upper threshold.

In the example shown, the controller 15 is configured to control operation of the fan assembly 134 in a first operating mode based on the first sensed temperature (e.g., motor temperature) not satisfying a first thermal threshold MT1 and the second sensed temperature (e.g., control temperature) not satisfying a third thermal threshold CT1. The controller 15 can control operation of the fan assembly 134 in a second operating mode based on one of the first sensed temperature satisfying the first thermal threshold MT1 and the second sensed temperature satisfying the third thermal threshold CT1. In some examples, the controller 15 can cause the fan assembly 134 to not generate the flow of cooling fluid in the first mode and the controller 15 causes the fan assembly 134 to generate the flow of cooling fluid in the second mode. The thermal threshold CT1 is greater than the thermal threshold MT1 in the example shown.

In the example shown, the controller 15 can be configured to control operation of the fan assembly 134 in a third operating mode based on one of the first sensed temperature satisfying a second thermal threshold MT2 and the second sensed temperature satisfying a fourth thermal threshold CT2. In some examples, the third thermal threshold CT1 is intermediate the first thermal threshold MT1 and the second thermal threshold MT2. The fourth thermal threshold CT2 can be greater than each of the first thermal threshold MT1, the second thermal threshold MT2, and the third thermal threshold CT1.

In the example shown in FIG. 14, the secondary conditions are based on the operating speed of electric motor 12. The secondary condition can be considered to be a speed threshold for the rotational speed of rotor 22. The speed of fan assembly 134 is determined based on the secondary condition. In the example shown, the secondary condition is based on a first speed threshold ST1. The fan speeds FS1-FS6 are the speed that the controller 15 causes the fan assembly 134 to operate at given the primary and secondary conditions.

At control levels 202a, 202b, the controller 15 determines whether the first level primary conditions are satisfied. If the first level primary conditions are not satisfied, controller 15 operates fan assembly 134 according to control level 202a. The controller 15 causes fan assembly 134 to operate at fan speed FS1 based on the sensed motor speed being less than the motor speed threshold MS1 such that the secondary condition is not met. The controller causes fan assembly 134 to operate at fan speed FS2 based on the sensed motor speed being greater than or equal to the motor speed threshold MS1. In some examples, the fan speeds FS1 and FS2 are the same. In some examples, the fan speeds FS1 and FS2 are each equal to zero such that the fan assembly 134 is not operated at control level 202a. If the sensed motor temperature does not meet lower threshold MT1 and the sensed control temperature does not meet lower threshold CT1, then the fan assembly 134 is controlled at fan speed FS1 or fan speed FS2. It is understood that one or both of fan speeds FS1 and FS2 can be zero such that fan assembly 134 is disabled when neither lower threshold MT1, CT1 is satisfied. In some examples, the controller 15 further defaults to control level 202a if power to drive system 10 is switched off.

If either the motor temperature satisfies the lower temperature threshold MT1 or the control temperature satisfies the lower temperature threshold CT1, then controller 15 controls operation of fan assembly 134 at control level 202b. At control level 202b, the controller 15 varies the speed of the fan assembly 134 based on the sensed speed of the electric motor 12. The controller 15 determines a commanded operating speed for fan assembly 134 based on the sensed speed of electric motor 12.

In the example show, if the speed of electric motor 12 satisfies the speed threshold ST1, then controller 15 causes fan assembly 134 to operate at fan speed FS4. For example, fan speed FS4 can be about 100% of the full operating speed of fan assembly 134. As such, controller 15 can cause fan assembly 134 to operate at full speed while controlling in control level 202b. If the speed of electric motor 12 does not satisfy the speed threshold ST1, then controller 15 causes fan assembly 134 to operate at fan speed FS3. The fan speed FS3 can be less than the full operating speed of fan assembly 134. In some examples, the fan speed FS3 can be about 30% of the full operating speed of fan assembly 134. It is understood, however, that other speed levels for fan assembly 134 are possible, such as about 20%, about 40%, about 50%, etc.

The controller 15 continues to control operation of fan assembly 134 at control level 202b until the motor temperature decreases below the lower threshold MT1 and the control temperature decreases below the lower threshold CT1, or until a primary condition of control level 202c is satisfied. In some examples, the controller 15 reverts to control level 202a based on the sensed temperature falling below the associated lower threshold by an offset value, as discussed in more detail above.

The controller 15 can vary the speed of the fan assembly 134 while operating in the second operating mode as the speed of the electric motor 12 varies. If the speed of the electric motor 12 drops below the speed threshold ST1, then controller 15 will cause fan assembly 134 to operate at fan speed FS3, whereas if the speed of the electric motor 12 increases above the speed threshold ST1, then controller 15 will cause fan assembly 134 to operate at fan speed FS2.

The controller 15 is configured to control the speed of fan assembly 134 based on control level 202c if at least one of the primary conditions of control level 202c are satisfied. In the example shown, the controller 15 is configured to control fan assembly 134 based on control level 202c if the motor temperature satisfies upper threshold MT2, if the control temperature satisfies upper threshold CT2, if an alarm is active, or if the electric motor 12 is operating in a reduced power mode.

The controller 15 causes fan assembly 134 to operate at fan speed FS5 based on the sensed motor speed being less than the motor speed threshold MS1 such that the secondary condition is not met. The controller causes fan assembly 134 to operate at fan speed FS6 based on the sensed motor speed being greater than or equal to the motor speed threshold MS1. In some examples, the fan speeds FS5 and FS6 are the same.

In some examples, at control level 202c the speed of the fan is set independently of the operating speed of electric motor 12 such that fan speeds FS5 and FS6 are equal and do not vary with variations in the speed of the electric motor 12. For example, both fan speed FS5 and fan speed FS6 can be set at 100% of the full operating speed of fan assembly 134.

If either the motor temperature satisfies the upper temperature threshold MT2 or the control temperature satisfies the upper temperature threshold CT2, then controller 15 controls operation of fan assembly 134 based on control level 202c.

The controller 15 can be configured to control operation of fan assembly 134 based on control level 202c in the event an alarm is active. The alarm can be a thermal alarm that triggers based on a sensed temperature exceeding an alarm threshold. For example, the controller 15 can be configured to operate in the control level 202c based on one or more thermal alarms. The first thermal alarm is associated with a sensed temperature of the electric motor 12 and can also be referred to as a motor temperature alarm. The motor temperature alarm is set to trigger based on the temperature data from sensor 162a indicating that the temperature has exceeded a motor thermal alarm threshold. The motor thermal alarm threshold can be greater than the upper threshold MT2. As such, the motor temperature alarm is set to trigger in the event that the temperature sensed by sensor 162a continues to rise even with the controller 15 controlling the fan assembly 134 based on control level 202c. The second thermal alarm is associated with a sensed temperature of the controller 15 and can also be referred to as a control temperature alarm. The control temperature alarm is set to trigger based on the temperature data from sensor 162b indicating that the temperature has exceeded a control thermal alarm threshold. The control thermal alarm threshold can be greater than the upper threshold CT2. As such, the control temperature alarm is set to trigger in the event that the temperature continues to rise even with the controller 15 controlling the fan assembly 134 based on control level 202c.

The alarms can be configured such that the alarm remains active even if the alarm condition is remedied. For example, the alarm can remain active even though the sensed temperature has fallen below the thermal alarm threshold. In some examples, the alarm condition requires active clearance by a user before the alarm will deactivate and reset. For example, a notification can be provided to the user via user interface 17 to indicate that an alarm condition is active. In some examples, the user must power down the spray system 1 to clear the alarm. In some examples, the temperature must also fall below the alarm threshold for the alarm to be cleared.

The controller 15 can be configured to control operation of fan assembly 134 based on control level 202c in the event that electric motor 12 is operating in a specific operating mode, such as a reduced power mode. A reduced power mode is an operating mode in which the power levels provided to the electric motor 12 (e.g., electric current) are reduced based on temperature information for drive system 10. For example, the maximum operating power that can be provided to electric motor 12 can be reduced in the event the sensed temperature exceeds some threshold level. The controller 15 then limits the maximum driving power provided to electric motor 12 to less than the maximum driving power that can be provided when not operating in the reduced power mode. The controller 15 operating electric motor 12 in a reduced power mode can cause controller 15 to default to operating fan assembly 134 based on control level 202c.

In the example shown, each control level 202 is triggered by a single primary condition being true. An example operation is discussed in more detail. Spray system 1 is activated and utilized to pump paint, such as for spraying. The electric motor 12 generates heat and sensor 162a provides motor temperature information to controller 15. The controller 15 generates heat and sensor 162b provides control temperature information to controller 15. As discussed above, the control temperature information can be generated based on the temperature at or around a component of controller 15, such as the IGBT. Additionally or alternatively, the component of controller 15 can be thermally connected by heatsink 126 by a direct thermal path, such as by being thermally bonded to heatsink 126. Controller 15 is initially at control level 202a and controls operation of fan assembly 134 based on control level 202a.

The temperatures of the electric motor 12 and controller 15 increase as spray system 1 is operated. If one of the lower threshold MT1 is satisfied by the motor temperature or the lower threshold CT1 is satisfied by the control temperature, the controller 15 operates in control level 202b. In control level 202b, the controller 15 activates fan assembly 134.

While operating in the second control mode at control level 202b, the controller 15 causes the fan assembly 134 to blow the cooling fluid through cooling circuit 140. Controller 15 bases the speed of fan assembly 134 on the sensed speed of electric motor 12 while operating in control level 202b. In the example shown, if the motor speed meets or exceeds (in some examples, exceeds) the motor speed threshold ST1, then the controller 15 causes the fan assembly 134 to operate at fan speed FS4. If the motor speed is below (in some examples, meets or is below) the motor speed threshold ST1, then the controller 15 causes the fan assembly 134 to operate at fan speed FS3. Fan speed FS3 is slower than fan speed FS4. Fan speed FS3 corresponding with a relatively lower speed of electric motor 12 reduces the noise generated by fan assembly 134 while electric motor 12 is operating slower and also generating relatively less noise. Reducing fan speed in relation to reduced motor speed reduces wear on fan assembly 134, prolonging operating life. The reduced noise of fan assembly 134 at relatively lower speeds of electric motor 12 makes operation of fan assembly 134 less noticeable to a user.

If the overtemperature parameter reduces below the associated lower threshold (e.g., threshold MT1 for motor temperature or threshold CT1 for control temperature) then controller 15 will revert back to operating in control level 202a. In such an example, the controller 15 deactivates fan assembly 134 and fan assembly 134 is not operated until cooling is again needed.

The temperatures of drive system 10 can continue to increase. If any of the primary conditions associated with control level 202c are met, then controller 15 controls fan assembly 134 based on control level 202c. In the example shown, if any one of upper threshold MT2 is satisfied by the motor temperature, the upper threshold CT2 is satisfied by the control temperature, the motor temperature alarm is triggered, the control temperature alarm is triggered, or a specific operating condition of the motor 12 is entered into, the controller 15 operates in the third control mode and controls fan assembly 134 based on control level 202c. At control level 202c the controller 15 causes the fan assembly 134 to operate. The fan assembly 134 is operated at fan speed FS5 or fan speed FS6 depending on motor speed. In some examples, fan speeds FS5 and FS6 are the same such that fan speed is independent of motor speed. In some examples, fan speeds FS5 and FS6 can be the same as fan speed FS4.

The controller 15 continues to operate in control level 202c until none of the primary conditions of control level 202c are satisfied. As discussed above, the alarm conditions can remain active until sufficient cooling occurs and the alarm is actively cleared. As such, controller 15 can continue to operate in control level 202c regardless of the sensed motor temperature and sensed control temperature so long as an alarm condition remains active.

As temperature falls, the controller 15 can revert from control level 202c to control level 202b and then from control level 202b to control level 202a. By way of example, assume both the motor temperature exceeds the upper threshold MT2 and the control temperature exceeds the upper threshold CT2 causing controller 15 to operate in control level 202c. If one of the thermal conditions is cleared (e.g., falls below the associated upper thermal threshold or falls below the associated upper threshold by an offset value), then controller 15 continues to operate at control level 202c based on the other thermal parameter remaining above its associated upper thermal threshold. If both of the thermal conditions are cleared (e.g., falls below the associated upper thermal threshold or falls below the associated upper threshold by an offset value), then controller 15 reverts to operating at control level 202b.

Controller 15 controls operation of fan assembly 134 at control level 202b until the one or more thermal conditions are cleared relative to the lower thermal thresholds (e.g., falls below the associated lower thermal threshold or falls below the associated lower threshold by an offset value). If the thermal conditions are cleared relative to the lower thresholds, then controller 15 reverts back to operating fan assembly 134 at control level 202a. Fan assembly 134 is disabled until again triggered to operate by a sensed thermal condition.

In some examples, such as when a thermal alarm is triggered to cause controller 15 to operate in control level 202c, the controller 15 can revert directly from control level 202c to control level 202a. For example, the alarm can remain active even after the monitored temperatures fall below the one or more lower temperature thresholds (e.g., lower threshold MT1, lower threshold CT1). Once the alarm is actively cleared, the controller 15 will operate in control level 202a based on the sensed temperatures being below the lower thresholds.

In one example, controller 15 can implement thermal offset when reverting between control levels 202. In such an example, the controller 15 reverts from control level 202b to control level 202a based on the over-threshold temperature falling to the thermal threshold plus an additional offset value, such as three degrees C. For example, if the motor temperature is the lower over-threshold temperature, then controller 15 will continue to operate in the control level 202b until the sensed motor temperature falls three degrees below the lower threshold MT1. For example, if the lower threshold MT1 is 95-degrees C., then the controller 15 will not shift to control level 202a until the sensed motor temperature falls to 92-degrees C. If the control temperature is the over-threshold temperature, then controller 15 will continue to operate at control level 202b until the sensed control temperature falls three degrees below the lower threshold CT1. If both the motor temperature and the control temperature are over-threshold, then controller 15 will continue to operate at control level 202b until the sensed control temperature falls three degrees below the lower threshold CT1 and the sensed motor temperature falls three degrees below the lower threshold MT1.

In the example shown, the primary operating condition determines whether fan assembly 134 is operated to generate the flow of cooling fluid. If the primary condition is satisfied, then the fan assembly 134 is operated and the flow of cooling fluid is generated and flowed through cooling circuit 140. The secondary operating condition determines a speed at which fan assembly 134 is operated. In the example shown, the secondary operating condition does not determine whether fan assembly 134 is or is not activated; instead, the secondary operating condition determines the operating characteristics of fan assembly 134 when operating. In the example discussed, the fan assembly 134 is activated based on the primary condition being satisfied. The fan assembly 134 remains deactivated so long as the primary condition is not satisfied. The secondary condition does not cause activation or deactivation of fan assembly 134. It is understood, however, that not all examples are so limited. In some examples, the secondary condition can determine whether fan assembly 134 is or is not activated. For example, the secondary condition can be whether electric motor 12 is powered and the fan speed associated with the secondary condition not being satisfied (e.g., when electric motor 12 is not powered) can be set to zero such that fan assembly 134 does not operate unless both the primary and secondary conditions are satisfied.

Control routine 1000 and active cooling of drive system 10 provide significant advantages. Fan assembly 134 is operated to provide cooling fluid to drive system 10 when such cooling is actually required. The speed of fan assembly 134 can be controlled based on the rotational speed of rotor 22 when relatively lesser levels of cooling are required and can be controlled independent of motor speed when relatively greater levels of cooling are required. Such a configuration facilitates provision of sufficient cooling while also reducing wear on fan assembly 134 and reducing noise generated by fan assembly 134.

While the invention(s) has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention(s) without departing from the essential scope thereof. Therefore, it is intended that the invention(s) not be limited to the particular embodiment(s) disclosed, but that the invention(s) may include all embodiments falling within the scope of the appended claims. Any single feature, or any combination of features from one embodiment show herein, may be utilized in a different embodiment independent from the other features shown in the embodiment herein. Accordingly, the scope of the invention(s) and any claims thereto are not limited to the particular to the embodiments and/or combinations of the features shown herein, but rather can include any combination of one, two, or more features shown herein.

1. A fluid sprayer, the fluid sprayer comprising:
a pump that outputs fluid under pressure;
a spray gun that sprays fluid output from the pump;
an electric motor having a rotor that rotates about a first axis;
a drive that receives rotational motion output by the electric motor to operate the pump;
a frame that supports the pump and the electric motor; and
a fan assembly that generates a flow of cooling fluid that cools the motor, the fan assembly having a blade structure that rotates on a second axis, the second axis non-coaxial with the first axis.

2. The fluid sprayer of claim 1, wherein the first axis is transverse to the second axis.

3. The fluid sprayer of claim 2, wherein the first axis is orientated orthogonal to the second axis.

4. (canceled)

5. (canceled)

6. The fluid sprayer of claim 1, wherein the second axis is orientated within 10 degrees of vertical.

7. (canceled)

8. The fluid sprayer of claim 1, wherein the fan assembly is located directly vertically below the electric motor.

9. The fluid sprayer of claim 1, wherein the fan assembly is mounted on the frame independent of the pump and the electric motor.

10. The fluid sprayer of claim 1, wherein the fan assembly is mounted within a duct at least partially defined by the frame.

11. The fluid sprayer of claim 10, wherein the duct projects vertically downward.

12. The fluid sprayer of claim 10, wherein the duct is open radially outward relative to the first axis such that a flow of cooling fluid generated by the fan assembly flows radially towards the first axis.

13-17. (canceled)

18. The fluid sprayer of claim 1, wherein the electric motor is located within a chamber, the fan assembly blows cooling fluid into the chamber, and the cooling fluid exhausts from the chamber via a vent.

19. The fluid sprayer of claim 18, wherein the vent is located above the electric motor and the fan assembly is located below the electric motor.

20-23. (canceled)

24. The fluid sprayer of claim 18, wherein the vent is oriented to exhaust heated cooling fluid longitudinally away from the pump.

25. (canceled)

26. The fluid sprayer of claim 18, wherein the chamber is bounded by a first wall, a second wall, a pair of lateral walls, a floor, and a ceiling.

27. The fluid sprayer of claim 26, wherein the first wall is formed by the frame.

28. The fluid sprayer of claim 26, wherein the second wall is formed by a heatsink.

29. The fluid sprayer of claim 28, wherein the heatsink is disposed between the chamber and a control cavity within which a controller is disposed.

30. The fluid sprayer of claim 29, wherein at least a portion of the controller is mounted directly to the heatsink.

31. (canceled)

32. (canceled)

33. The fluid sprayer of claim 29, wherein the heatsink is axially aligned with the motor such that the first axis passes first through the heatsink and then through the control cavity.

34-64. (canceled)

65. A fluid sprayer, the fluid sprayer comprising:
a pump that outputs fluid under pressure;
a spray gun that sprays fluid output from the pump;
an electric motor having a rotor that rotates about a first axis;
a drive that receives rotational motion output by the electric motor to operate the pump;
a frame that supports the pump and the electric motor;
a fan assembly that generates a flow of cooling fluid that cools the motor, the fan assembly having a blade structure that rotates on a second axis; and
a cooling circuit having a chamber within which the electric motor is at least partially disposed, a cooling inlet configured to provide cooling fluid from the fan assembly to the chamber, and a cooling outlet configured to output heated cooling fluid from the chamber.

66-78. (canceled)

79. A fluid sprayer, the fluid sprayer comprising:
a pump that outputs fluid under pressure;
a spray gun that sprays fluid output from the pump;
an electric motor having a rotor that rotates about a first axis;
a drive that receives rotational motion output by the electric motor to operate the pump;
a frame that supports the pump and the electric motor;
a chamber within which the electric motor is at least partially disposed;
a fan assembly that generates a flow of cooling fluid that cools the motor and that is configured to blow the flow of cooling fluid into the chamber, the fan assembly having a blade structure that rotates on a second axis; and
a heatsink forming at least one wall of the chamber, the heatsink exposed to the flow of cooling fluid generated by the fan assembly.

80-137. (canceled)
